(19) United States
(12) Patent Application Publication
(10) Pub. No.: US 2003/0143427 A1
(43) Pub. Date: Jul. 31, 2003

(54) Exciton forming substance, luminescent material using the substance, method for light emission and luminescent element, and device using the element

(76) Inventors: Mikiko Matsuo, Nara-shi (JP); Tetsuya Satou, Kadoma-shi (JP); Hisanori Sugiura, Hirakata-shi (JP); Hitoshi Hisada, Toyonaka-shi (JP)

Correspondence Address: PARKHURST & WENDEL, L.L.P., 1421 PRINCE STREET, SUITE 210, ALEXANDRIA, VA, 22314-2805, US

(21) Appl. No.: 10/297,997

(22) PCT Filed: Jun. 12, 2001
(86) PCT No.: PCT/JP01/04978

(30) Foreign Application Priority Data
Jun. 13, 2000 (JP) 2000-176433

(51) Int. Cl. H05B 33/14; C09K 11/06

(52) U.S. Cl. 428/690; 428/917; 252/301.16; 313/504; 257/88

(57) ABSTRACT

The invention provides a luminescent material that has a wide optimum concentration range, makes the controlling of the concentration easy in mass production processes, and makes it easy to obtain uniformity and reproducibility within the device or between the devices The invention also provides a light-emitting device using the luminescent material and a system using the light-emitting device. In addition, a light-emitting device is provided which shows good color purity, does not reduce current efficiency in the high luminance region, and does not degrade the lifetime characteristics. The luminescent material includes an exciton-forming substance and a luminescent substance. The exciton-forming substance is such that the energy level difference between the excited singlet state and the excited triplet state is 2 eV or lower. The luminescent substance is such that the energy level of the excited singlet state is equal to or lower than the energy level of the excited triplet state of the exciton-forming substance.

### TECHNICAL FIELD

The present invention relates to an exciton-forming substance, a luminescent material using the exciton-forming substance, a method of producing luminescence and a light-emitting device using the luminescent material, and a system using the light-emitting device.

### BACKGROUND ART

In recent years, with the diversification of information devices, there have been growing needs for flat panel display devices that are thinner and consume less power than CRTs. In particular, electroluminescent devices are receiving attention because they are self-luminous and provide a clear display and wide viewing angles. The electroluminescent device is largely divided into inorganic and organic electroluminescent devices by the constituent material.

However, the inorganic electroluminescent device requires the application of a high voltage of 100 V or more for operation, resulting in an increase in the cost of peripheral devices. In addition, luminescent materials that provide excellent blue luminescence are not available, making it impossible to obtain a full-color display.

On the other hand, the organic electroluminescent device is known as an injection-type light-emitting device in which electric charges (holes and electrons) injected from the anode and the cathode recombine in the luminescent material and thus excitons are formed, and then the excitons excite the molecules of the luminescent material, thereby emitting light. Therefore, the organic electroluminescent device can be driven at low voltages. Furthermore, because the luminescent material is an organic compound, the molecular structure of the luminescent material can be easily altered, making it possible to obtain desired luminescent colors.

For the organic electroluminescent device, first, such a device structure was developed that had an organic thin film of a two-layer structure including a thin film m ade of a hole transport material and a thin film made of an electron transport material, and that emitted light by recombination of electrons and holes injected in the organic thin film from the respective electrodes (Applied Physics Letters, 51, 1987, P. 913).

In addition, a three-layer structure including a hole transport material, a luminescent material, and an electron transport material was developed (Japanese Journal of Applied Physics, Vol. 27, No. 2, P. 269). There was also reported a device in which a fluorescent dye was doped in the luminescent layer to increase the performance of the device (Journal of Applied Physics, 65, 1989, P. 3610, Japanese Unexamined Patent Publication No. 63-264692). In these reports, there was provided a device in which a fluorescent dye such as a coumarin derivative or DCM1 was doped in an organic luminescent layer made of tris(8-quinolinolato)aluminum (hereinafter referred to as Alq₃), and it was found that the luminescent color could be changed by appropriately selecting dyes. Further, the reports revealed that the luminescent efficiency was also enhanced as compared to the case of undoping. For the dopant, fluorescent dyes with high quantum efficiencies such as laser dyes are generally used. However, use of fluorescent dye alone does not provide sufficient thin film forming properties. Thus, by doping a fluorescent dye in a host material with good thin film forming properties, luminescence can be obtained.

FIGS. 15(a) to 15(c) are schematic views illustrating doping mechanism. FIG. 15(a) is a schematic view illustrating undoped luminescence with a dopant not being doped. FIG. 15(b) illustrates energy transfer, with a dopant being doped in luminescent molecules, from the luminescent molecules to the dopant. FIG. 15(c) illustrates the luminescence of the dopant in which the energy transfer has been completed.

For the undoped luminescence, the luminescent layer is made of a host luminescent substance 11. Holes and electrons recombine between luminescent molecules of the host, thereby forming excitons, and then the luminescent molecules of the host themselves emit light. In the luminescent layer, the host luminescent substance 11 does not emit light all at once. Specifically, as shown in FIG. 15(a), in the luminescent layer there exist luminescent molecules 12 which are not emitting light and luminescent molecules 13 which are emitting light.

Next, as shown in FIG. 15(b), when a dopant 16 is added, the energy of the luminescent molecules of the host transfers to the dopant 16 by energy transfer (Forster transfer) 17. Forster transfer is based on the dipole oscillation of molecules and thus does not require direct contact between molecules. Therefore, even in a long distance that is much longer than a contact distance (on the order of 10 nm), energy transfer occurs. Consequently, as shown in FIG. 15(c), the dopant 16 is excited, whereby the dopant itself provides luminescence 18.

In doping techniques, luminescence obtained from the device depends on dopants with high quantum efficiencies, and thus it is possible to enhance the luminescent efficiency. When the luminescent efficiency is enhanced, the load on the device upon operation can be reduced, achieving increased lifetimes. In addition, by selecting the type of dopants, desired luminescent colors can be obtained, making it easy to realize a color display.

In order to further improve the characteristics of the device, Japanese Unexamined Patent Publication No. 7-65958 suggested that an organic substance for improving the valence band levels at the interfaces between organic layers was doped in an organic luminescent layer or in a carrier transporting layer, thereby preventing carriers from being accumulated in the vicinity of the interface between the organic luminescent layer and the carrier transporting layer. Thereby, the time to half luminance was increased.

Furthermore, Japanese Unexamined Patent Publication No. 8-48656 suggested an organic EL device in which the hole transporting layer was made of various triphenyldiamine This publication also discloses the doping of rubrene in the electron transporting layer or in the hole transporting layer, thereby enhancing the electroluminescent efficiency with respect to electric current and increasing luminescence lifetimes.

Meanwhile, an attempt has been made to enhance the luminescent efficiency by enhancing the exciton-forming efficiency. In organic light-emitting devices, as the luminescent substance, fluorescent substances are generally used. Substances that form luminescent layers are fluorescent substances, e.g., a dopant as disclosed in Japanese Unexamined Patent Publication No 63-264692.

As a result of recombination of electrons and holes, electrically neutral excitons are formed. Luminescence occurs through these excitons. The excitons to be formed include a mix of singlet and triplet excitons. The exciton-forming ratio is statistically and theoretically such that the singlet exciton:the triplet exciton=1:3. Accordingly, an exciton that contributes to luminescence by fluorescence is the singlet exciton with 25%, and the triplet exciton with the rest of 75% does not contribute to luminescence. Hence, the triplet exciton ends up being consumed as heat, and thus luminescence occurs from the singlet exciton with a low exciton-forming rate. In recent years, studies have been conducted on the effective use of energy having been transferred to the triplet exciton, for luminescence. Specifically, in order to obtain phosphorescence emission, first, material development has been carried out, and consequently a high luminescent efficiency is achieved (for example, Applied Physics Letters, 75, 1999, P. 4). Further, this luminescent substance for emitting a phosphorescent light was used as a sensitizer so that the energy of the luminescent substance for emitting a phosphorescent light was transferred to the dopant by Forster transfer. Thereby, even higher efficiency was achieved (for example, Nature, 403, 2000, P. 750).

The above-described methods for improving the characteristics of the EL device, however, have advantages and disadvantages. So far there has not been found any method that meets all requirements including, for example, electroluminescent efficiency, device lifetime, reproducibility, etc.

In the stage of practical utilization, doping methods, for example, have difficulties controlling the doping concentration at mass production. Specifically, upon doping, when the doping concentration is increased, the color purity is improved, however, this causes concentration quenching, resulting in a reduction in luminescent efficiency. By contrast, when the doping concentration is reduced, the energy of the host material cannot be sufficiently absorbed. Therefore, as a result of the addition of luminescence of the host to luminescence of the dopant, colors are mixed with one another, reducing the color purity. Thus, in doping methods, upon handling dopants, careful attention must be given to the controlling of the concentration. The foregoing Japanese Unexamined Patent Publication No. 63-264692 discloses that the fluorescent substance level is sufficient at as small as about 10 mole % or less. In practice, a fluorescent substance is used in an amount of up to on the order of 1 wt % relative to the host material, and thus the optimum concentration range is narrow. Hence, in mass production processes, it is difficult to control the concentration, making it difficult to obtain uniformity and reproducibility within the device or between the devices.

Moreover, as disclosed in Japanese Unexamined Patent Publication No. 7-65958, doping materials for improving the valence band level such as rubrene have a narrower band gap than aluminumquinoline serving as an organic luminescent material. Hence, EL emission to be obtained is shifted to wavelengths longer than green luminescence of aluminumquinoline. The luminescence mechanism is believed to be equivalent to the mechanism shown in FIGS. 15(a) to 15(c). In the example section of Japanese Unexamined Patent Publication No. 7-65958, there has been disclosed that a rubrene-doped material had an emission maximum wavelength (X max) of 550 nm and DCM, originally a red-emitting dopant, also had an emission maximum wavelength of 550 nm. The luminescence of organic materials has a wide spectrum width. Thus, in obtaining a green color with good color purity in the organic light-emitting device, an emission maximum wavelength of in the neighborhood of 530 nm is said to be appropriate. As a matter of fact, the example section of Japanese Unexamined Patent Publication No. 8-48656 discloses that when the emission maximum wavelength is 550 nm, yellow luminescence is obtained. Thus, when the valence band level is improved, the EL spectrum is shifted towards longer wavelengths. Therefore, even when a green luminescent material is used, yellow luminescence is caused which is broadly spread on the long wavelength side. In general, the display consists of three primary colors, R (red), G (green), and B (blue), and thus a reduction in the color purity is not desirable. For phosphorescence emission, the phosphorescence emission by optical excitation occurs by a transition from an excited singlet state to an excited triplet state via intersystem crossing. In the EL device, on the other hand, electrons and holes recombine, thereby directly forming an excited triplet state. However, since the transition from the excited triplet state to the ground singlet state by radiation is a forbidden transition, the phosphorescence lifetime is long. It is generally said that the cause of low efficiency of phosphorescence is attributed to its lifetime rather than the forbidden system, and while phosphorescence stays in the excited triplet state, phosphorescence is adversely affected such as deactivation from outside or thermal deactivation. In the case of duty driving for practical use, the instantaneous luminance reaches as high as several thousand to several ten thousand cd/m², and thus a high luminescent efficiency must be maintained even in the high luminance region. In the case of utilizing phosphorescence, the radiation process of phosphorescence is slow especially in the high luminance region, and therefore the recombination of electrons and holes to be injected is saturated, reducing the current efficiency in the high luminance region.

Techniques that use, as a sensitizer, a luminescent substance for emitting a phosphorescent light involve at least two steps of energy transfer that utilizes phosphorescence emission, which possibly leads to a loss of luminescent efficiency by the product of the two conversion efficiencies. Further, because the band gap is narrowed stepwise, a blue luminescence is difficult to obtain.

In the device configuration that utilizes phosphorescence, the exciton diffusion distance is increased due to the lifetime length of phosphorescence, and thus excitons need to be trapped in the luminescent layer. Generally, a hole blocking layer is provided between a phosphorescence emission layer and an electron transporting layer made, for example, of aluminumquinoline, so as to prevent excitons, formed in the phosphorescence emission layer, from diffusing to the vicinity of the cathode of the electron transporting layer and suffering from cathode quenching. At present, the effective material for forming the hole blocking layer is limited to phenanthroline derivatives such as Bathocuproin, which narrows down the material selection. In addition, when the hole blocking layer is stacked between the phosphorescence emission layer and the electron transporting layer, the luminescent efficiency is enhanced by the exciton-trapped effect. However, because of a significant increase in the operating voltage, the lifetime characteristics are degraded.

### DISCLOSURE OF THE INVENTION

In view of the foregoing and other problems, it is an object of the present invention to provide a luminescent material which has a wide optimum concentration range, makes the controlling of the concentration easy in mass production processes, and makes it easy to obtain uniformity and reproducibility within the device or between the devices, a light-emitting device using the luminescent material, and a system using the light-emitting device.

It is another object of the present invention to provide a light-emitting device which shows good color purity, does not reduce current efficiency in the high luminance region, and does not degrade the lifetime characteristics.

All of the embodiments are based on the same or similar concepts. However because each of the embodiments has been realized by different examples, the embodiments have been divided into a first invention group, a second invention group, etc. by grouping together those embodiments that are closely related. In the following, the details of each section (invention group) are described in order.

(1) First Invention Group

The first invention group relates to the finding of an exciton-forming substance that easily forms an excited triplet state. The exciton-forming substance referred to in the present invention is a substance capable of transferring excited energy to luminescent molecules by energy transfer accompanied by electron exchange. The energy transfer accompanied by electron exchange refers to such energy transfer that is generally called an electron exchange mechanism.

In electroluminescent devices, luminescence occurs, as described above, by the recombination of electrons and holes. The electron and hole in a device made of an organic material exhibit an anion radical state and a cation radical state, respectively. That is, the recombination of electrons and holes means that one electron in the anion radical state enters the cation radical state, thereby forming an excited state. Here, in the field of quantum chemistry where the molecule is understood as one system, the wave function of the entire system can be expressed by the product of the wave function of a spin part and the wave function of an orbital part. The excited state can be described as follows.

First, for the spin part, there are divided into electron 1, an unpaired electron of a cation radical, and electron 2, an unpaired electron of an anion radical. The electrons take α spin and β spin, depending on the spin direction, and accordingly it is understood that the combinations of these spins include four spin states as shown in equations (1) and (2).

α(1)β(2)-α(2)β(1) (1)

$$\begin{matrix}α ( 1 ) β ( 2 ) + α ( 2 ) β ( 1 ) \\ α ( 1 ) α ( 2 ) \\ β ( 1 ) β ( 2 )\end{matrix} \qquad ( 2 )$$

Equation (1) indicates a spin part in the singlet state, and three equations in equation (2) indicate a spin part in the triplet state. In the formation of excitons by the recombination of electrons and holes, the a spin and the B spin are equivalent, and thus the formation ratio of the singlet state to the triplet state is statistically and theoretically 1:3.

Now, the wave function of the orbital part is examined. The state of electrons in the excited state is assumed to be such that one electron is present in each of the highest occupied molecular orbital (hereinafter referred to as HOMO) and the lowest unoccupied molecular orbital (hereinafter referred to as LUMO) When these electrons are divided into electron 1 and electron 2, the wave function of a molecular orbital that represents a singlet can be represented by equation (3) and the wave function of a molecular orbital that represents a triplet by equation (4).

$$1 / \sqrt{2} [ {Ψ}_{HOMO}^{( 1 )} {Ψ}_{LUMO}^{( 2 )} + {Ψ}_{LUMO}^{( 1 )} {Ψ}_{HOMO}^{( 2 )} ] \qquad ( 3 )$$

In the Huckel molecular orbital (HMO) theory, the molecular orbital can be represented by the linear combination of atomic orbitals. Considering atoms A and B, the HOMO and LUMO can be represented by equations (5) and (6), respectively.

ψ_{HOMO}=1/\sqrt{2}(s_{A}+x_{B}) (5)

ψ_{LIMO}=1/\sqrt{2}(x_{A}−_{B}) (6)

From equations (5) and (6), equation (3) which represents the singlet and equation (4) which represents the triplet can be represented by equations (7) and (8), respectively.

x_{A}(1)x_{A}(2−x_{B}(1)x_{B}(2) (7)

x_{B}(1)x_{A}(2)+x_{A}(1)x_{B}(2) (8)

From equation (7), it is understood that in the singlet state electron 1 and electron 2 are localized in atom A or atom B, indicating that the molecule has ionicity. From equation (8), it is understood that in the triplet state when electron 1 is present in atom B, electron 2 is present in atom A, and conversely, when electron 1 is present in atom A, electron 2 is present in atom B, indicating that the molecule is in a biradical state. These facts show that the electron in the triplet state is free-electron-like and moves easily.

In the present invention, a substance capable of forming, with a high formation probability, an excited triplet state having a free-electron-like electron is referred to as an exciton-forming substance. Use of such an exciton-forming substance allows to transfer excited energy to a host luminescent substance that can emit light without a dopant being doped. Consequently, luminescence of the luminescent substance is induced, enhancing the luminescent efficiency. Such an exciton-forming substance can be used in various chemical reactions accompanied by energy transfer or electron exchange.

Specifically, the present invention provides an exciton-forming substance, wherein an energy level difference between an excited singlet state and an excited triplet state is 2 eV or lower. The exciton-forming substance is also brought to the excited singlet and triplet states by, as is the case described above, recombination of electrons and holes. In this case also, the formation probability is statistically and theoretically 1:3. When the energy level difference between the excited singlet state and the excited triplet state is 2 eV or lower, an exciton-forming substance formed in the excited singlet state also transits to the excited triplet state, making it possible to efficiently form an exciton-forming substance in the excited triplet state.

The above-described exciton-forming substance may be such that an energetically stable configuration in a cation radical state and an energetically stable configuration in an excited state resemble each other, and that a transition from the cation radical state to the excited state is energetically advantageous.

When the energetically stable configuration in the cation radical state and the energetically stable configuration in the excited state resemble each other, the change in configuration is small upon transition. Accordingly, the transition from the cation radical state to the excited state is energetically advantageous.

In particular, it is preferred that the above-described exciton-forming substance be such that an energetically stable configuration in a cation radical state and an energetically stable configuration in an excited triplet state resemble each other, and that a transition from the cation radical state to the excited triplet state is energetically advantageous.

It is desirable that the above-described exciton-forming substance be an organic compound represented by the following general formula (1):

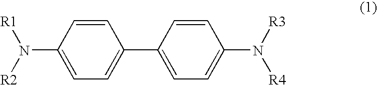

wherein R1 to R4 are each independently selected from the group consisting of an aryl group having 6 to 18 carbon atoms and a heteroaromatic ring having 1 to 3 nitrogen atoms, may be substituted with one or more substituents selected from the group consisting of an alkyl group having 1 to 6 carbon atoms, an aryl group having 6 to 18 carbon atoms, a heteroaromatic ring having 1 to 3 nitrogen atoms, a vinyl group, a styryl group, and a diphenylvinyl group, and may be the same or different; and R1 and R2 and/or R3 and R4 may be combined together to form a saturated or unsaturated five- or six-membered ring or a fused polycyclic aromatic ring.

The above-described exciton-forming substance may be an organic compound represented by the following general formula (2):

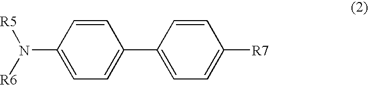

wherein R5 and R6 each independently selected from the group consisting of an aryl group having 6 to 18 carbon atoms and a heteroaromatic ring having 1 to 3 nitrogen atoms, may be substituted with one or more substituents selected from the group consisting of an alkyl group having 1 to 6 carbon atoms, an aryl group having 6 to 18 carbon atoms, and a heteroaromatic ring having 1 to 3 nitrogen atoms, a vinyl group, a styryl group, and a diphenylvinyl group, may be the same or different, and may be combined together to form a saturated or unsaturated five- or six-membered ring or a fused polycyclic aromatic ring; and R7 is selected from the group consisting of hydrogen, an alkyl group having 1 to 6 carbon atoms, an aryl group having 6 to 18 carbon atoms, a heteroaromatic ring having 1 to 3 nitrogen atoms, a vinyl group, a styryl group, and a diphenylvinyl group.

(2) Second Invention Group

The second point of the present invention relates to the finding of a 5 luminescent material using the above-described exciton-forming substance. Specifically, the present invention provides a luminescent material, comprising: an exciton-forming substance; and a luminescent substance.

For example, the luminescent material may comprise: an exciton-forming substance wherein an energy level difference between an excited singlet state and an excited triplet state is 2 eV or lower; and a luminescent substance wherein an energy level of an excited singlet state is equal to or lower than an energy level of the excited triplet state of the exciton-forming substance.

As described above, the exciton-forming substance of the present invention has such properties as to easily form an excited triplet state Waiting for free-electron-like electrons present in the exciton-forming substance in the excited triplet state to follow through with the radiation process as phosphorescence causes the following problem due to the long-lived triplet state. Specifically, the excited triplet state is not only adversely affected fiom outside such as triplet quenching by oxygen present in the device, but also possibly suffers from radiationless deactivation by an intramolecular triplet quenching mechanism. However, when a luminescent substance is present in the vicinity of an exciton-forming substance in the excited triplet state, the luminescent substance being such that the energy level of the excited singlet state is equal to or lower than the energy level of the excited triplet state of the exciton-forming substance, the excited energy of the exciton-forming substance can be efficiently transferred to the luminescent substance. The reason for this is thought to be that electrons with a fee-electron-like behavior in the substance in the triplet state according to the foregoing equation (8) are exchanged with electrons in the luminescent substance in the ground state. Consequently, excitation of the luminescent substance is induced, enhancing the luminescent efficiency.

The luminescent material of the present invention may comprise: an exciton-forming substance wherein an energetically stable configuration in a cation radical state and an energetically stable configuration in an excited triplet state resemble each other, and wherein a transition from the cation radical state to the excited triplet state is energetically advantageous; and a luminescent substance wherein an energy level of an excited singlet state is equal to or lower than an energy level of the excited triplet state of the exciton-forming substance.

For such an excitorn-forming substance, any of the above-described exciton-forming substances may be used.

The number of moles of the exciton-forming substance contained in the above-described luminescent material may be equal to or less than the number of moles of the luminescent substance. When the number of moles of the exciton-forming substance is equal to or less than the number of moles of the luminescent substance, a high luminescent efficiency can be maintained with no dependency on the concentration of the exciton-forming substance. Hence, with this configuration, the controlling of the optimum concentration range is not as difficult as in the case of dopant in doping methods, and it is suitable for mass production. By contrast, when the number of moles of the exciton-forming substance exceeds the number of moles of the luminescent substance, exciton annihilation occurs due to a collision between molecules of the substance in the excited triplet states, and thus such a configuration is not desirable.

(3) Third Invention Group

The above-described luminescent substances emit light by the following mechanism.

The present invention provides a method of producing luminescence in a luminescent substance, comprising: applying a voltage to an luminescent material, the luminescent material comprising: an exciton-forming substance wherein an energy level difference between an excited singlet state and an excited triplet state is 2 eV or lower; and a luminescent substance wherein an energy level of an excited singlet state is equal to or lower than an energy level of the excited triplet state of the exciton-forming substance.

The luminescent substance used in the present invention itself can emit light by recombination of electrons and holes. In other words, this luminescent substance can emit light, even if an exciton-forming substance is not present, by application of a voltage. In addition, since an exciton-forming substance is present, the luminescent substance is excited by energy transfer accompanied by electron exchange with the exciton-forming substance in the excited state, thereby enhancing luminescence. Accordingly, the luminescent efficiency of the luminescent substance is dramatically increased. Although a specific principle of luminescence is under study now, it is assumed that luminescence is based on the luminescence mechanism shown in FIGS. 1(a) to 1(c). The luminescence is explained below with reference to FIGS. 1(a) to 1(c).

FIGS. 1(a) to 1(c) schematically illustrate the luminescence mechanism of the present invention. FIG. 1(a) illustrates the luminescence of a luminescent substance with an exciton-forming substance being not present. FIG. 1(b) illustrates energy transfer, with an exciton-forming substance being added to the luminescent substance, from the exciton-forming substance to the luminescent substance. FIG. 1(c) illustrates the luminescence of the luminescent substance in which the energy transfer has been completed.

As can be seen from FIG. 1(a), when an exciton-forming substance is not present, in a luminescent substance 11 there exist, when observed at the same time, molecules 13, which are emitting light by recombination of electrons and holes, and molecules 12 which are not emitting light.

When an exciton-forming substance 14 is added to the luminescent substance 11, as shown in FIG. 1(b), the exciton-forming substance 14 is also excited to an excited triplet state by recombination of electrons and holes. The exciton-forming substance 14 in the excited triplet state is capable of allowing the luminescent substance in the ground state to perform energy transfer 15 accompanied by electron exchange. The electron exchange is performed between excited electrons of the exciton-forming substance 14 in the excited state and electrons in the HOMO of the luminescent substance 12 in the ground state. Such energy transfer 15 is generally called Dexter transfer. Dexter transfer is energy transfer that occurs within a contactable distance that allows for molecular orbital overlap, through the exchange of electron wave movement. In general, Dexter transfer is energy transfer that is accompanied by electron exchange in a solution. However, since the light-emitting device is a solid device, molecules are present adjacent to each other, and thus energy is transferred by Dexter transfer, thereby exciting adjacent molecules. Thus, by Dexter transfer, the luminescent molecules go into the excited state accompanied by electron exchange, whereby the luminescent molecules go into the excited singlet state or the excited triplet state, as shown in FIG. 1(c), producing luminescence 13.

Luminescence of a luminescent substance may also be produced by Dexter transfer, as is the case above, by applying a voltage to a luminescent material, the luminescent material comprising: an exciton-forming substance wherein an energetically stable configuration in a cation radical state and an energetically stable configuration in an excited triplet state resemble each other, and wherein a transition from the cation radical state to the excited triplet state is allowed; and a luminescent substance wherein an energy level of an excited singlet state is equal to or lower than an energy level of the excited triplet state of the exciton-forming substance.

(4) Fourth Invention Group

Light-emitting devices using the above-described luminescent materials can be configured as follows.

The present invention provides a light-emitting device comprising an anode, a cathode, and a luminescent layer sandwiched between the anode and the cathode, wherein the luminescent layer contains a luminescent material, the luminescent material comprising: an exciton-forming substance; and a luminescent substance.

The above-described Light-emitting device uses the above-described luminescent material, and thus a light-emitting device with a high luminescent efficiency and a long lifetime can be provided.

The light-emitting device of the present invention may be such that in the luminescent layer the exciton-forming substance is dispersed in the luminescent substance.

When the exciton-forming substance is dispersed in the luminescent substance, a distance where Dexter transfer from the exciton-forming substance to the luminescent substance is easily performed, can be secured.

The exciton-forming substance may be uniformly dispersed in the luminescent substance or may be dispersed in the luminescent substance with a concentration gradient. When the exciton-forming substance is dispersed in the luminescent substance with a concentration gradient, it is preferred that the exciton-forming substance be dispersed in the luminescent substance with a concentration gradient in a thickness direction of the luminescent layer, the gradient being such that concentration increases towards the cathode.

The above-described luminescent layer may be of a multilayer structure, the multilayer structure comprising: an exciton-forming layer containing the above-described exciton-forming substance; and a luminescent substance layer containing the above-described luminescent substance. Even if the luminescent layer is of a multilayer structure, energy of the exciton-forming substance in the excited triplet state formed in the exciton-forming layer can be transferred, by Dexter transfer, to the luminescent substance in the luminescent substance layer. In the exciton-forming layer, although exciton annihilation may occur due to a collision between molecules of the exciton-forming substance in the excited triplet states, there is formed sufficient exciton-forming substance in the excited triplet state to increase the luminescence of the luminescent substance.

The above-described multilayer structure may comprise the exciton-forming layer, the luminescent substance layer, and the exciton-forming layer stacked on top of each other in sequence from the anode side.

Electrons to be injected from the cathode have behavior to fall to a lower energy level, and thus move in the order of the cathode, electron transporting layer, exciton-forming layer, luminescent substance layer, exciton-forming layer, hole transporting layer, and anode. On the other hand, holes to be injected from the anode have behavior to rise to a higher energy level, and thus move in the order of the anode, hole transporting layer, exciton-forming layer, luminescent substance layer, exciton-forming layer, electron transporting layer, and cathode. Recombination of electrons and holes takes place mainly in the luminescent substance layer and the exciton-forming layers provided at both sides of the luminescent substance layer. In the exciton-forming layer, the exciton-forming substance is excited to an excited triplet state by the recombination of electrons and holes With this configuration, the exciton-forming substances in the excited triplet state formed in the exciton-forming layers that are provided in contact with both interfaces of the luminescent layer can be utilized for luminescence of the luminescent substance in the luminescent substance layer, and thus a high luminescent efficiency can be obtained.

The above-described multilayer structure may comprise the luminescent substance layer, the exciton-forming layer, and the luminescent substance layer stacked on top of each other in sequence from the anode side.

With this configuration, the exciton-forming substance in the excited triplet state formed in the exciton-forming layer can be utilized for luminescence of the luminescent substances in the luminescent layers provided in contact with both interfaces of the exciton-forming layer, and thus the exciton-forming substance in the excited triplet state can be efficiently utilized.

The above-described multilayer structure may comprise a multilayer unit having a structure including the luminescent substance layer and the exciton-forming layer stacked on top of each other in sequence from the anode side.

With such a configuration, for the same reason as that described above, the exciton-forming substance in the excited triplet state formed in the exciton-forming layer can be utilized for luminescence of the luminescent substance in the luminescent substance layer. In cases where the multilayer structure comprises a plurality of the multilayer units, more intense luminescence can be obtained from each luminescent substance layer as compared with the case where only the luminescent substance is present, and thus the luminescent efficiency can be further enhanced.

The number of the above-described multilayer unit may be in a range of 1 to 250. When the number of the multilayer unit exceeds more than 250, because each multilayer unit has a given thickness, the thickness of the entire luminescent layer becomes thick. As a result, the applied voltage to produce luminescence needs to be increased, which in turn decreases the luminescent efficiency, easily causing deterioration of the light-emitting device. Thus, such a configuration is not desirable.

The total number of moles of the above-described exciton-forming substance contained in the above-described multilayer structure may be equal to or less than the total number of moles of the above-described luminescent substance contained in the above-described multilayer structure.

When the total number of moles of the above-described exciton-forming substance contained in the multilayer structure is equal to or lower than the total number of moles of the above-described luminescent substance contained in the multilayer structure, exciton annihilation due to a collision between molecules of the exciton-forming substance does not occur, as is in the case above, and thus the excitons can be effectively utilized for luminescence of the luminescent substance.

The thickness of the above-described multilayer structure may be 4 nm to 1000 nm. When the thickness of the multilayer structure exceeds more than 1000 nm, the applied voltage needs to be increased to produce luminescence with a given luminance, which in turn decreases the luminescent efficiency, easily causing deterioration of the device. On the other hand, when the thickness of the multilayer structure is less than 4 nm, insulation breaks and the like are easily caused, reducing the lifetime of the device.

In the luminescent substance layer and the exciton-forming layer that form the above-described multilayer structure and are stacked on top of each other, it is preferred that the thickness of the exciton-forming layer be equal to or less than that of the luminescent substance layer. When the exciton-forming layer is thicker than the luminescent substance layer, exciton annihilation resulting from a collision between molecules of the exciton-forming substance is increased so much that the excitons cannot be effectively utilized for luminescence of the luminescent substance.

The present invention provides a light-emitting device comprising an anode, a cathode, and a luminescent layer sandwiched between the anode and the cathode, the luminescent layer emitting light by electron-hole recombination, wherein: the luminescent layer containing a luminescent material, the luminescent material comprising an exciton-forming substance and a luminescent substance; and the electron-hole recombination between luminescent substance molecules is promoted by energy transfer from the exciton-forming substance to the luminescent substance, the energy transfer being accompanied by electron exchange between the luminescent substance and the exciton-forming substance in an excited triplet state. For such a luminescent material, any of the above-described luminescent materials can be used.

The present invention provides a light-emitting device comprising an anode, a cathode, and a luminescent layer sandwiched between the anode and the cathode, wherein the luminescent layer comprises: a host material containing a luminescent substance; and a guest material made of an exciton-forming substance and contained in the host material, wherein luminescence from the host material is obtained.

The host and guest materials, as used in the present invention, have the same meaning as in the case of semiconductors. A material that contains a luminescent substance is referred to as the host material, and an impurity that is mixed to improve the characteristics of the host material is referred to as the guest material. As is shown in FIGS. 15(a) to 15(c), in conventional doping methods, a dopant is mixed and a guest material, the dopant, is allowed to emit light, thereby changing luminescent colors and enhancing the luminescent efficiency. On the other hand, the guest material of the present invention itself does not emit light, but is mixed as an assistant material for increasing the luminescent intensity of the host. In terms of this, the luminescence mechanism of the present invention differs from that of conventional doping methods. Accordingly, the EL spectrum of the present invention is such a spectrum that is attributed to luminescence of the host material, regardless of whether or not the guest material is present. Specifically, the wavelengths of the luminescence of the host material do not change, and therefore the luminescent efficiency can be enhanced while maintaining the stability of chromaticity. In addition, since the guest material has a low concentration dependency, as is described above, the reproducibility is improved within the device or between the devices and the uniformity can also be improved.

As described above, when the luminescent material of the present invention is used, the exciton-forming substance does not emit light for the following reasons. Because intersystem crossing occurs in the exciton-forming substance, fluorescent radiation is hardly emitted from the exciton-forming substance in the excited singlet state. In addition, the exciton-forming substance in the excited triplet state transfers energy to the luminescent substance at a rate much faster than the energy transfer performed by phosphorescent radiation. With this configuration, since the luminescent substance does not emit phosphorescent radiation, the exciton diffusion distance can be made very short, which eliminates the necessity of a hole blocking layer and the like for trapping excitons. Consequently, a light-emitting device with simple configuration can be provided.

The present invention provides a light-emitting device comprising an anode, a cathode, and a luminescent layer sandwiched between the anode and the cathode, wherein the luminescent layer comprises: an exciton-forming substance wherein an energy level difference between an excited singlet state and an excited triplet state is 2 eV or lower; and a luminescent substance for emitting visible light wherein an energy level of an excited singlet state is equal to or lower than an energy level of the excited triplet state of the exciton-forming substance, and wherein electron affinity is greater than that of the exciton-forming substance. When such a configuration is employed, the luminance of visible light emission can be increased. Also, the luminance of blue luminescence can be effectively increased. For the exciton-forming substance, any of the above-described exciton-forming substances can be used.

(5) Fifth Invention Group

Systems using the above-described light-emitting devices can be configured as follows.

The present invention provides a display device comprising an image signal output portion for generating image signals, a driving portion for generating an electric current in accordance with the image signals generated by the image signal output portion, and a luminescence portion for emitting light in accordance with the electric current generated by the driving portion, wherein: the luminescence portion includes at least one light-emitting device; and the light-emitting device is any of the above-described light-emitting devices.

The above-described display device may be such that a plurality of the light-emitting devices are arranged in a matrix on a substrate.

The above-described display device may be such that the light-emitting devices are stacked on a substrate having formed thereon thin film transistors for controlling an operation of the light-emitting devices.

The present invention provides a lighting system comprising a driving portion for generating an electric current and a luminescence portion for emitting light in accordance with the electric current generated by the driving portion, wherein: the luminescence portion includes at least one light-emitting device; and the light-emitting device is any of the above-described light-emitting devices.

### BRIEF DESCRIPTION OF THE DRAWINGS

FIGS. 1(a) to 1(c) schematically illustrate the luminescence mechanism of the present invention.

FIG. 1(a) illustrates the luminescence of a luminescent substance with an exciton-forming substance being not present.

FIG. 1(b) illustrates energy transfer, with an exciton-forming substance being added to the luminescent substance, from the exciton-forming substance to the luminescent substance.

FIG. 1(c) illustrates the luminescence of the luminescent substance in which the energy transfer has been completed.

FIG. 2 is a schematic view illustrating one example of a light-emitting device that can be used in the present invention.

FIG. 3 is a schematic view illustrating one example of a light-emitting device of the present invention.

FIG. 4 is a schematic view illustrating another example of a light-emitting device of the present invention.

FIG. 5 illustrates one example of a light-emitting device of the present invention having a luminescent layer of a multilayer structure.

FIG. 6 illustrates another example of a light-emitting device of the present invention having a luminescent layer of a multilayer structure.

FIG. 7 illustrates still another example of a light-emitting device of the present invention having a luminescent layer of a multilayer structure.

FIG. 8 illustrates another example of a light-emitting device of the present invention having a luminescent layer of a multilayer structure.

FIG. 9 illustrates yet another example of a light-emitting device of the present invention having a luminescent layer of a multilayer structure.

FIG. 10 illustrates another example of a light-emitting device of the present invention having a luminescent layer of a multilayer structure.

FIG. 11 illustrates the structure of CBP.

FIGS. 12(a) to 12(c) illustrate the spatial relationships of rotation axis directions between Cz1, Cz2, b1, and b 2 of CBP.

FIG. 12(a) illustrates the spatial relationship of rotation axis directions between Cz1, Cz2, b1, and b2 of CBP in a cation radical state.

FIG. 12(b) illustrates the spatial relationship of rotation axis directions between Cz1, Cz2, b1, and b2 of CBP in an excited singlet state.

FIG. 12(c) illustrates the spatial relationship of rotation axis directions between Cz1, Cz2, b1, and b2 of CBP in an excited triplet state.

FIG. 13 is a schematic view illustrating one example of a display device using the light-emitting devices of the present invention.

FIG. 14 is a schematic view illustrating one example of a lighting system using the light-emitting device of the present invention.

FIGS. 15(a) to 15(c) are schematic views illustrating doping mechanism.

FIG. 15(a) is a schematic view illustrating undoped luminescence with a dopant not being doped.

FIG. 15(b) illustrates energy transfer, with a dopant being doped in luminescent molecules, from the luminescent molecules to the dopant.

FIG. 15(c) illustrates the luminescence of the dopant in which the energy transfer has been completed.

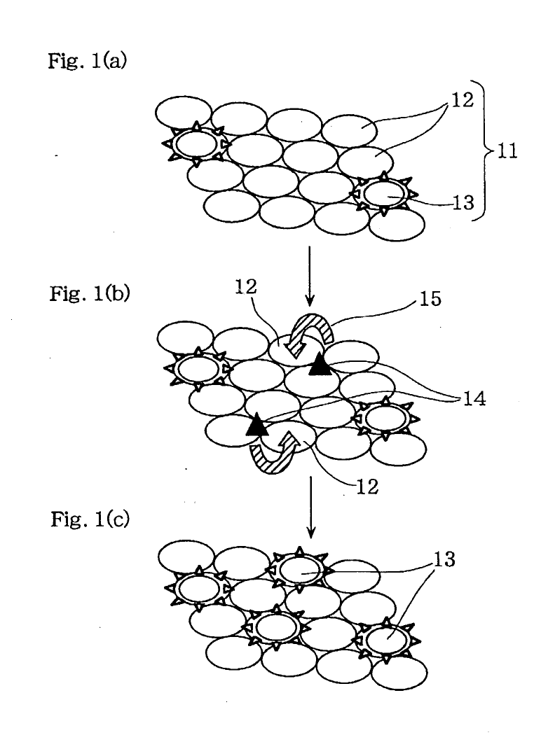

### BEST MODE FOR CARRYING OUT THE INVENTION

(1) Examples of the First Invention Group

In the following, the first invention group of the present invention is described with reference to the drawings.

In the exciton-forming substances of the present invention, the energy level difference between the excited singlet state and the excited triplet state is 2 eV or lower.

The energy levels of the excited singlet and triplet states of the exciton-forming substances and luminescent substances of the present invention can be determined by molecular orbital methods. By molecular orbital calculations, it is possible to determine energetically stable configurations in various molecular states, such as a ground state, an excited state, and a radical state, i.e., nuclear configurations (optimized structures) in which an energy change with respect to a very small positional change of the atomic nucleus is minimized. The energy obtained with these optimized structures is calculated, which is referred to as the energy level. The structures obtained experimentally by, for example, X-ray structure analysis are equilibrium structures where molecules are moving, e.g., vibrating or rotating. On the other hand, the optimized structures obtained by molecular orbital calculations are atomic configurations for the molecules with the minimum energy values in given states such as the ground state, excited state, and radical state

With molecular orbital calculations, it is possible to calculate until the energy change with respect to a very small positional change of the atomic nucleus, known as convergence, approaches zero. An example of a general purpose software for performing a molecular orbital calculation by an ab initio method includes the Gaussian 94 program. The default value for the convergence of this program is 10⁻⁷. Calculating until the convergence approaches zero improves calculation accuracy, however, the calculation takes a lot of time and the computer requires high performance, leading to a loss of the development cost. For molecular orbital calculations, semiempirical molecular orbital methods are well-known. For example, the WinMOPAC program (available from Fujitsu Limited) is a general-purpose and useful software for performing molecular orbital calculations by semiempirical molecular orbital methods. The default value for the convergence of this program is 1, which is larger than that of the former program. However, with the default value for the convergence of this program, a relative comparison between molecules or between states can be sufficiently performed and the limitations on calculation time and the capacity and processing speed of the computer are small, and thus this program is preferable. Accordingly, the term “energy level” as used herein refers to an energy calculated with a nuclear configuration in which the minimum value to the convergence is within 1.

The excited triplet state has lower energy than the excited singlet state. Therefore, in substances which easily cause intersystem crossing, the formed excited singlet state also transits to the excited triplet state. Consequently, in the substances which easily cause intersystem crossing, triplet excitons can be formed with almost 100% certainty. The smaller the energy level difference between the excited singlet state and the excited triplet state, the more likely the intersystem crossing takes place. In the exciton-forming substances of the present invention, “energy level difference between the excited singlet state and the excited triplet state is 2 eV or lower” means that the energy level difference calculated by WinMOPAC program AM1 (MNDO-Austin model 1) is 2 eV or lower.

As used herein, “energetically stable configurations in various states such as a cation radical state and an excited state” refers to nuclear structures configured, by molecular orbital calculations, such that energy is minimized. These structures are generally called optimized structures.

According to the spin multiplets given by equations (1) and (2), the exciton-formation probability is three times higher for triplet excitons than singlet excitons. In the formation of excitons, it is advantageous if a transition to an excited triplet state is easily performed. Therefore, when the recombination energy released at the transition from a cation radical state to an excited triplet state is smaller than the recombination energy released at the transition from a cation radical state to an excited singlet state, an excited triplet state can be formed more easily, and thus such a configuration is desirable. Furthermore, a configuration, where the optimized structure in a cation radical state and the optimized structure in an excited triplet state resemble each other, is energetically and structurally desirable.

Preferred examples of such exciton-forming substances include organic compounds represented by general formulae (1) and (2) above.

Specific examples of the organic compounds represented by general formula (1) above include 4,4,-N,N′-dicarbazole-biphenyl, N,N,N′,N′-tetraphenyl-1,1′-biphenyl-4,4′-diamine, N,N′-bis(4′-diphenylamino-4-biphenyl)-N,N′-diphenylbenzidine, and the like.

Specific examples of the organic compounds represented by general formula (2) above include 4-[4-(2,2-diphenylviny1)phenyl]phenyl-diphenylamine, 4-[4-(2,2-diphenylvinyl)phenyl]bis(4-methylphenyl)amine, and the like.

Luminescent substances used in the luminescent materials of the present invention are not specifically limited so long as the luminescent substances are such that the energy level of the excited singlet state is equal to or lower than the energy level of the excited triplet state of the above-described exciton-forming substances. Thus, any known luminescent substance can be used. Specific examples include aluminumquinoline, derivatives thereof, 4,4′-bis(2,2-diphenylvinyl)biphenyl, tetraphenylporphin, and the like.

Of the organic compounds represented by general formulae (1) and (2) above, there are also included those that can be generally used as hole transport materials. It is to be noted, however, that the fact that the organic compounds represented by general formulae (1) and (2) above stimulate luminescence from luminescent molecules in the above-described mechanism was first found by the present inventors.

In the luminescent materials of the present invention, it is desirable that the number of moles of an exciton-forming substance contained in the luminescent material be equal to or less the number of moles of a luminescent substance. In order that excitons formed by an exciton-forming substance be more efficiently utilized for luminescence with a luminescent substance, it is preferred that the exciton-forming substance be present in an amount of 30 mole % or less relative to the luminescent substance In view of actual practice, it is normally sufficient that the luminescent material contains on the order of 10 mole % to 30 mole % exciton-forming substance.

The light-emitting device of the present invention includes a luminescent layer sandwiched between an anode and a cathode. The luminescent layer contains the above-described luminescent materials.

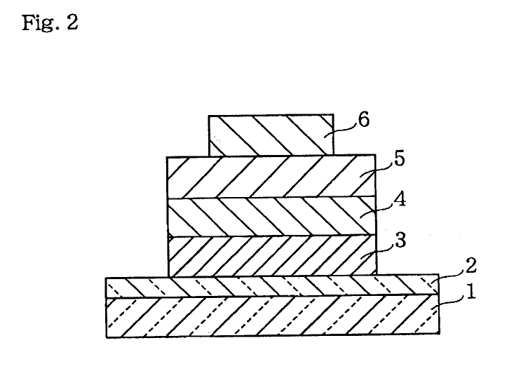

The light-emitting device of the present invention may include, in addition to the above-described luminescent layer, other functional layers. FIG. 2 is a schematic view illustrating one example of a light-emitting device that can be used in the present invention. For example, as shown in FIG. 2, the device may include, on a transparent substrate 1, an anode 2, a hole transporting layer 3, a luminescent layer 4, an electron transporting layer 5, and a cathode 6 stacked on top of each other in sequence. This configuration is commonly known as a DH structure.

In addition to the above-described configuration, an SH-A structure in which the luminescent layer 4 also functions as the electron transporting layer 5, an SH-B structure in which the luminescent layer 4 also functions as the hole transporting layer 3, and a single-layer structure in which the luminescent layer 4 also functions as both the hole transporting layer 3 and the electron transporting layer 5, can also be used as the light-emitting device of the present invention.

As used herein, the term “light-emitting device” means a device having, between a hole transporting electrode and an electron injecting electrode, a functional layer including at least a luminescent layer. The functional layer may be formed of layers that are all made of organic material, or may be formed of layers including a layer of inorganic material. For example, the electron transporting layer may be made of inorganic material and the hole transporting layer may be made of organic material. Conversely, the electron transporting layer may be made of organic material and the hole transporting layer may be made of inorganic material. Alternatively, any one or more of the hole transporting layer, the luminescent layer, and the electron transporting layer may be made of inorganic material.

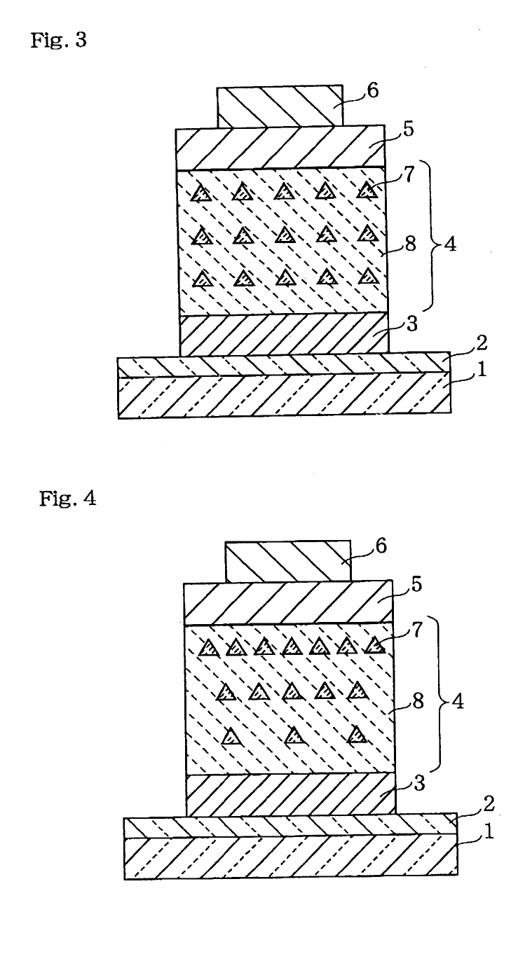

One example of a light-emitting device of the present invention has the luminescent layer 4, as shown in FIG. 3, in which the exciton-forming substance 7 is uniformly dispersed in the luminescent substance 8. Since the exciton-forming substance 7 is present in the neighborhood of the luminescent substance 8, energy transfer accompanied by electron exchange can be easily performed.

A light-emitting device having the structure shown in FIG. 3 can be fabricated, for example, as follows. A transparent substrate 1 is not specifically limited so long as the substrate has a moderate strength, is not adversely affected by heat upon deposition and the like when fabricating the device, and is transparent. Examples of materials for the transparent substrate 1 include glass (e.g., corning 1737 and the like), transparent resin, e.g., polyethylene, polypropylene, polyethersulfone, polycarbonate, polyetheretherketone, and the like. Not only the light-emitting device of the present embodiment, but also other light-emitting devices according to the present invention can be fabricated by sequentially stacking the layers on the transparent substrate 1.

Not only in the light-emitting device of the present embodiment, but also in all other light-emitting devices of the present invention, the anode, including an anode 2 shown in the drawing, is usually made of a transparent conductive film. As the material for such a transparent conductive film, it is desirable to use conductive substances having a work function higher than on the order of 4 eV. Examples of such substances include conductive compounds such as carbon, metals, e.g., aluminum, vanadium, iron, cobalt, nickel, copper, zinc, tungsten, silver, tin, gold, etc., and alloys of these metals, and conductive metal compounds such as metal oxides, e.g., tin oxide, indium oxide, antimony oxide, zinc oxide, zirconium oxide, etc., and solid solutions or mixtures of these metal oxides (e.g., ITO (indium tin oxide) and the like).

The anode 2 can be formed on the transparent substrate 1 by deposition, sputtering, or sol-gel method, using a conductive substance such as one described above, or alternatively by dispersing such a conductive substance in a resin or the like and applying the dispersed substance to the substrate, so that desired translucency and electrical conductivity can be ensured. In particular, in the case of an ITO film, deposition is performed by sputtering, electron-beam deposition, ion plating or the like, for the purpose of improving the transparency of the film or lowering the resistivity of the film.

The thickness of the anode 2 is determined by the required sheet resistance and visible light transmittance. In the case of light-emitting devices, since the driving current density is comparatively high, the sheet resistance needs to be lowered. For this reason, in most cases, the film thickness is 100 nm or more.

Next, on the anode 2, a hole transporting layer 3 is formed. For hole transport materials that can be used in forming the hole transporting layers of light-emitting devices of the present invention, including the hole transporting layer 3 shown in the drawing, known materials can be used, however, preferred materials are derivatives having, as the basic skeleton, triphenylamine with excellent luminescence stability and excellent durability.

Specific examples of the hole transport material include tetraphenylbenzidine compounds, triphenylamine-trimers, and benzidine dimers as disclosed in Japanese Unexamined Patent Publication No. 7-126615, various tetraphenyldiamine derivatives as disclosed in Japanese Unexamined Patent Publication No. 8-48656, N,N′-diphenyl-N,N′-bis(3-methylphenyl)-1,1′-biphenyl-4,4′-diamine (MTPD (commonly known as TPD)) as disclosed in Japanese Unexamined Patent Publication No. 7-65958, and the like. Triphenylamine tetramers as disclosed in Japanese Unexamined Patent Publication No. 10-228982 are more preferable. In addition, diphenylamino-α-phenylstilbene, diphenylaminophenyl-α-phenylstilbene, and the like can also be used. Further, inorganic materials for forming p-layers such as amorphous silicon may be used.

The thickness of the hole transporting layer 3 should be on the order of 10 nm to 1000 nm. When the thickness of the hole transporting layer is less than 10 nm, although a high luminescent efficiency is exhibited, insulation breaks and the like are easily caused, reducing the lifetime of the device. On the other hand, when the thickness of the hole transporting layer 3 exceeds more than 1000 nm, the applied voltage needs to be increased to produce luminescence with a given luminance, which in turn provides a poor luminescent efficiency and easily causes device degradation.

Subsequently, on the hole transporting layer 3, a luminescent layer 4 is formed. The luminescent layer of the light-emitting device shown in FIG. 3 contains, as is the case above, an exciton-forming substance and a luminescent substance.

The thickness of the luminescent layer 4 should be on the order of 5 nm to 1000 nm. When the thickness of the luminescent layer is less than 5 nm, although a high luminescent efficiency is exhibited, insulation breaks and the like are easily caused, reducing the lifetime of the device. On the other hand, when the thickness of the luminescent layer exceeds more than 1000 nm, the applied voltage needs to be increased to produce luminescence with a given luminance, which in turn provides a poor luminescent efficiency and easily causes device degradation. The preferred thickness is typically on the order of 5 nm to 100 nm.

In the luminescent layer 4, for the purpose of improving the charge transport properties, a hole transport material or an electron transport material may further be added in addition to the above-described luminescent material. As the luminescent substance, inorganic luminescent substances may be used. Further, a luminescent material may be dispersed in a polymer matrix.

On the luminescent layer 4, an electron transporting layer 5 is formed. As electron transport materials that can be used in forming the electron transporting layers of light-emitting devices of the present invention, including the electron transporting layer 5 shown in the drawing, known materials can be used. A preferred material is aluminumquinoline. Examples of other electron transport materials include metal complexes such as tris(4-methyl-8-quinolilato)aluminum, 3-(2′-benzothiazoly1)-7-diethylaminocoumarin, and the like.

The thickness of the electron transporting layer 5 should be on the order of 10 nm to 1000 nm. When the thickness of the electron transporting layer is less than 10 nm, although a high luminescent efficiency is exhibited, insulation breaks and the like are easily caused, reducing the lifetime of the device. On the other hand, when the thickness of the electron transporting layer exceeds more than 1000 nm, the applied voltage needs to be increased to produce luminescence with a given luminance, which in turn provides a poor luminescent efficiency and easily causes device degradation.

The hole transporting layer 3 and the electron transporting layer 5 may each be made of a single layer. However, in view of ionization potential and the like, those layers may each be made of a plurality of layers.

The hole transporting layer 3, the luminescent layer 4, and the electron transporting layer 5 may be formed by deposition, or alternatively by coating methods such as dip coating and spin coating, using a solution in which materials for forming such layers are dissolved, or using a solution in which materials for forming such layers are dissolved with suitable resins. The Langmuir-Blodgett (LB) method may also be employed. The preferred deposition is vacuum deposition. With the vacuum deposition, in the above-described layers, homogeneous layers in the amorphous state can be formed.

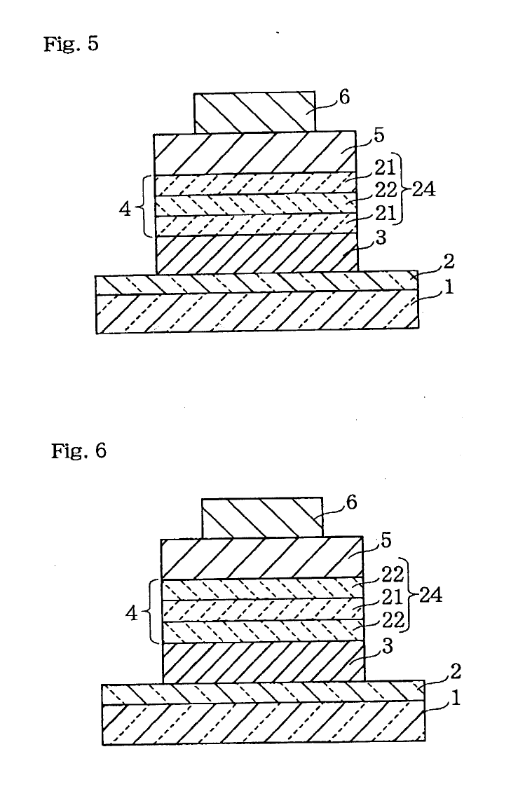

In the luminescent layer, as is shown in FIG. 4, in cases where the exciton-forming substance in the luminescent substance has a concentration gradient, a luminescent layer with a concentration gradient can be formed by controlling the temperature or concentration. In cases where the number of moles of the exciton-forming substance contained in the luminescent layer is equal to or less than the number of moles of the luminescent substance, the luminescent layer may be formed such that the number of moles of the exciton-forming substance : the number of moles of the luminescent substance=1:100 to 100:1.

The hole transporting layer 3, the luminescent layer 4, and the electron transporting layer 5 may be formed individually, however, it is desirable to form the layers successively in a vacuum. When the layers are formed successively, it is possible to prevent impurities from getting on the interfaces between the layers, preventing a reduction in operating voltage and improving characteristics, i.e., enhancement of the luminescent efficiency, increased lifetimes, and the like.

In cases where any of the hole transporting layer 3, the luminescent layer 4, and the electron transporting layer 5 contains a plurality of compounds, when the layers are formed by vacuum deposition, it is desirable to perform co-deposition with a plurality of boats, each containing a single compound, being individually subjected to temperature control, however, it is also possible to perform deposition using a mixture in which a plurality of compounds are mixed in advance.

It is also possible to form on the electron transporting layer 5 an electron injecting layer, though not shown in the drawing, to improve the electron injection and transport properties. As electron injection materials for forming the electron injecting layer, various types of known electron injection materials can be used. Preferred materials are, for example, alkali metals (e.g., lithium, sodium, and the like), alkaline-earth metals (e.g., beryllium, magnesium, and the like), and the salts and oxides of these metals.

The electron injecting layer can be formed, for example, by deposition or sputtering. The thickness of the layer should be on the order of 0.1 nm to 20 nm.

Next, on the electron transporting layer 5, a cathode 6 is formed. For the cathodes of light-emitting devices of the present invention, including the cathode 6 shown in FIG. 3, it is desirable to use alloys of low work function metals. In cases where the above-described electron injecting layer is formed, it is also possible to form thereon a layer of high work function metals such as aluminum and silver. In addition, even if the cathode is formed of a transparent or translucent material, planar luminescence can be extracted.

The cathode 6 is formed by deposition, sputtering or the like, using metal materials such as those described above. The thickness of the cathode 6 is preferably in the range of 10 nm to 500 nm, and more preferably in the range of 50 nm to 500 nm, in terms of electrical conductivity and manufacturing stability.

The luminescent layer may be of a multilayer structure including an exciton-forming layer containing the above-described exciton-forming substance and a luminescent substance layer containing the above-described luminescent substance.

The multilayer structure including the exciton-forming layer and the luminescent substance layer can be fabricated, for example, by alternately stacking a layer of the exciton-forming substance and a layer of the luminescent substance. The exciton-forming layer and the luminescent substance layer can be fabricated in the same manner as the luminescent layer.

FIG. 5 illustrates one example of a light-emitting device of the present invention in which the luminescent layer is of a multilayer structure. In this light-emitting device, the luminescent layer is of a multilayer structure 24 including an exciton-forming layer 21, a luminescent substance layer 22, and an exciton-forming layer 21 stacked on top of each other in sequence from the anode side.

FIG. 6 illustrates one example of a light-emitting device of the present invention in which the luminescent layer is of a multilayer structure. In this light-emitting device, the luminescent layer is of a multilayer structure 24 including a luminescent substance layer 22, an exciton-forming layer 21, and a luminescent substance layer 22 stacked on top of each other in sequence from the anode side.

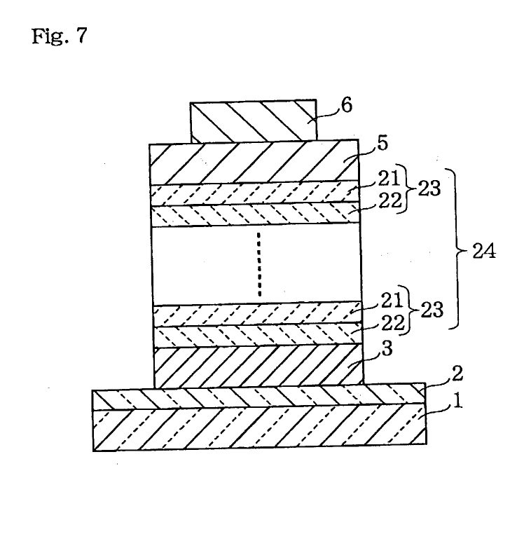

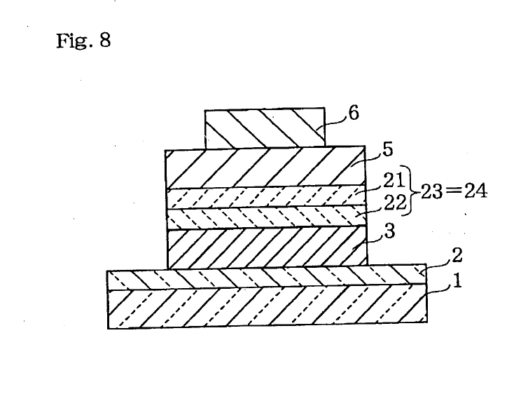

FIG. 7 illustrates another example of a light-emitting device of the present invention in which the luminescent layer is of a multilayer structure. A multilayer structure 24 may include, as shown in FIG. 7, multilayer units 23, each having a structure including a luminescent substance layer 22 and an exciton-forming layer 21 stacked on top of each other in sequence from the anode side. The number of the multilayer units 23 is not specifically limited, but is preferably in the range of 1 to 250. As was described above, of the exciton-forming substances of the present invention, there are included those that can be generally used as hole transport materials. However, as shown in FIG. 8, even if an exciton-forming layer 21 is provided only between a luminescent substance layer 22 and an electron transporting layer 5, the luminescent efficiency can be enhanced. FIG. 8 illustrates still another example of a light-emitting device of the present invention in which the luminescent layer is of a multilayer structure.

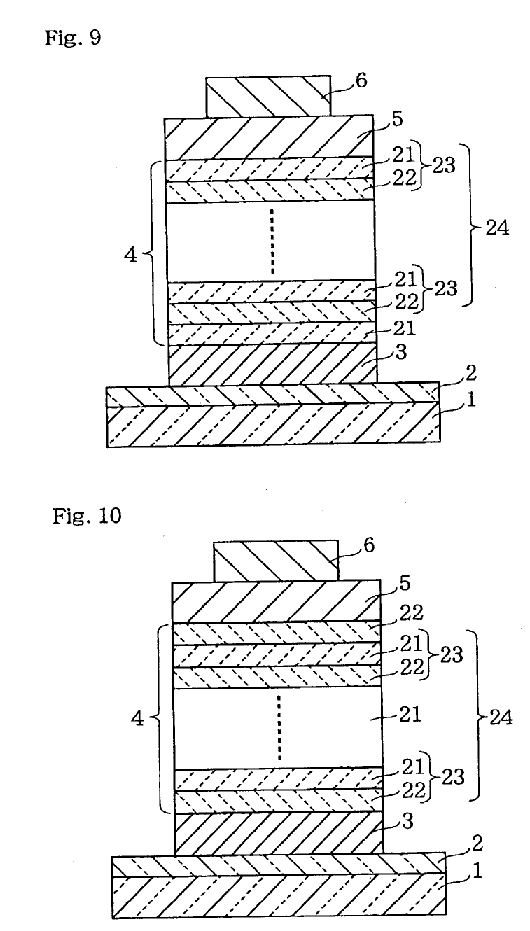

FIG. 9 illustrates yet another example of a light-emitting device of the present invention in which the luminescent layer is of a multilayer structure. As shown in FIG. 9, a luminescent layer 4 may be configured such that an exciton-forming layer 21 is provided between a multilayer structure 24, which includes a plurality of multilayer units 23, and a hole transporting layer 3.

As shown in FIG. 10, a luminescent layer 4 may be configured such that a luminescent substance layer 22 is provided between a multilayer structure 24, which includes at least one multilayer unit 23, and an electron transporting layer 5.

Even in the case where the luminescent layer is of a multilayer structure including an exciton-forming layer containing the above-described exciton-forming substance and a luminescent substance layer containing the above-described luminescent substance, it is desirable that the total number of moles of the exciton-forming substance contained in the multilayer structure be equal to or less than the total number of moles of the luminescent substance contained in the multilayer structure. With this configuration, exciton annihilation, resulting from a collision between molecules of the exciton-forming substance formed in the excited triplet states, can be prevented.

The thickness of the luminescent substance layer that forms the multilayer structure should be 3 nm to 100 nm. When the thickness of the luminescent substance layer is 3 nm, the luminescent layer has a thickness that is about twice the distance that Dexter transfer is performed, and therefore energy can be effectively transferred to the luminescent substance, enhancing the luminescent efficiency. On the other hand, when the thickness of the luminescent substance layer exceeds more than 100 nm, Dexter transfer occurs only at the interface between the luminescent layer and the exciton-forming layer, and energy transfer from the exciton-forming layer cannot be effectively performed, and thus such a configuration is not desirable.

The thickness of the exciton-forming layer that forms the multilayer structure should be 1 nm to 10 nm. Recombination of electrons and holes occurs between the molecules of the exciton-forming substance, thereby forming an excited state. In cases where the average size of the organic molecules is about 1 nm, the thickness of the exciton-forming layer should be 1 nm which corresponds to the thickness of a monolayer. On the other hand, when the thickness of the exciton-forming layer exceeds more than 10 nm, exciton annihilation occurs in the exciton-forming layer due to a collision between molecules in the triplet states, and energy transfer to the luminescent substance layer cannot be effectively performed. Thus, such a configuration is not desirable.

In the light-emitting devices of the present invention, in cases where the luminescent layer includes a plurality of multilayer units, the luminescent layers and/or the exciton-forming layers may have the same or different thickness, so long as the thickness is in the above-described range.

The thickness of the multilayer structure should be 4 nm to 1000 nm, and preferably 9 nm to 1000 nm, in view of the thickness of the luminescent substance layer and the thickness of the exciton-forming layer.

In the luminescent substance layer and the exciton-forming layer that form the multilayer structure and are stacked on top of each other, the thickness of the exciton-forming layer is preferably equal to or less than that of the luminescent substance layer.

Furthermore, in order to improve the charge transport properties, the above-described hole transport material or electron transport material may be added to the luminescent layer.

In the light-emitting devices of the present invention, even if luminescent substances for emitting visible light are used as luminescent dyes, energy transfer, which is accompanied by electron exchange with the exciton-forming substance in the excited triplet state, can be performed. Accordingly, the light-emitting devices of the present invention can also contribute to increasing the luminance of visible light emission.

In view of the electron affinity of general luminescent substances for emitting visible light, the electron affinity of the exciton-forming substance should be 3.2 eV or less. As used herein, the term “electron affinity” refers to the difference between the ionization potential value to be measured and the band gap value obtained from the long wave and long end of the absorption spectrum. The ionization potential can be measured by an ultraviolet photoelectron spectrometer (for example, AC-1 available from Riken Keiki Co., Ltd.) under an atmosphere. It is to be noted, however, that comparing theses, etc. there is great variation in the electron affinity value. Therefore, the value of 3.2 eV mentioned above is not absolute. The importance is that the electron affinities of the exciton-forming substances of the present invention are smaller than those of luminescent substances for emitting visible light.

The luminescent material of the present invention includes a luminescent substance and an exciton-forming substance for increasing luminescence of the luminescent substance. Thus, regardless of whether the luminescent color of the luminescent substance is red, green, or blue, the luminescent efficiency can be enhanced without causing the colors to be mixed with one another, and thus high-grade display devices and high-grade lighting systems can be provided. A display device may be such that a plurality of light-emitting devices of the present invention are arranged in a matrix on a substrate, or such that the light-emitting devices of the present invention are stacked on a substrate having provided thereon thin film transistors for controlling the operation of the light-emitting devices. For lighting systems, as novel light sources with planar luminescence, new lighting space can be created. In addition, the lighting systems can be applied to other optical applications.

The description of the present invention is provided in detail below with reference to the examples.

### EXAMPLE 1

In this example, preferred exciton-forming substances were investigated. As an organic compound represented by general formula (1) above, 4,4′-N,N′-dicarbazole-biphenyl (hereinafter referred to as CBP) was investigated for the structural optimization, using an AM1 method which is a semiempirical molecular orbital method. For the program, WinMOPAC (available from Fujitsu Limited) was used. The structural optimization of the molecule of the above-described compound was performed for the three states, an excited singlet state, an excited triplet state, and a cation radical state.

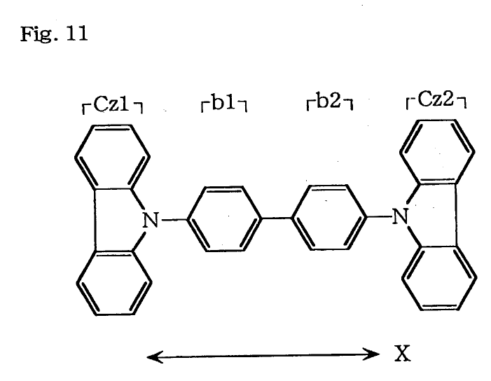

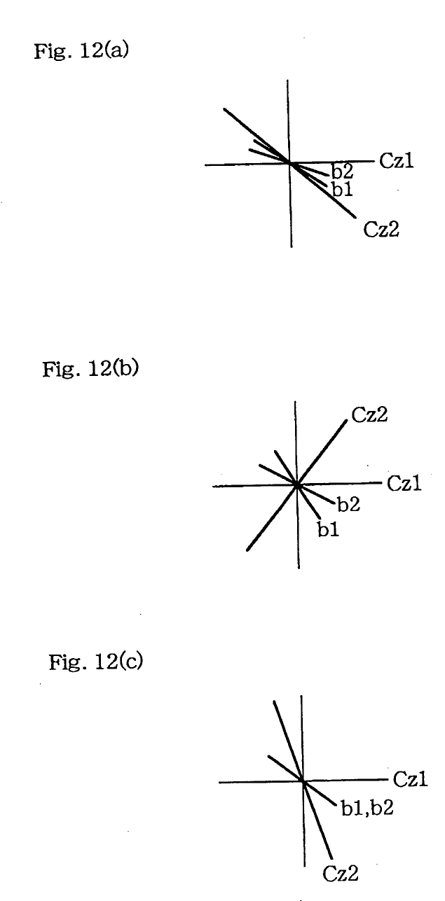

The molecule was composed, as shown in FIG. 11, of four aromatic rings, i.e., two carbazole rings (Cz) and two benzene rings (b). The rings are referred to as Cz1, Cz2, b1, b2, respectively. In FIG. 11, the direction of the rotation axis of Cz1, Cz2, b1, and b2 is referred to as X. The spatial relationships of rotation axis directions between Cz1, Cz2, b1, and b2, which were obtained from the optimized structures in the above-described three states, are shown in FIGS. 12(a) to 12(c). FIG. 12(a) illustrates the spatial relationship of rotation axis directions between Cz1, Cz2, b1, and b2 of CBP in the cation radical state FIG. 12(b) illustrates the spatial relationship of rotation axis directions between Cz1, Cz2, b1, and b2 of CBP in the excited singlet state. FIG. 12(c) illustrates the spatial relationship of rotation axis directions between Cz1, Cz2, b1, and b2 of CBP in the excited triplet state.

As can be seen from FIGS. 12(a) to 12(c), the excited triplet state (see FIG. 12(c)) and the cation radical state (see FIG. 12(a)) resemble each other in spatial arrangement. On the other hand, in the excited singlet state (see FIG. 12(b)), Cz2 is largely rotated with respect to Cz1, and thus the excited singlet state differs from the other two in spatial arrangement. As has already been described, when an excited state is formed by a single electron jumping to a cation radical, a singlet state and a triplet state are statistically. and theoretically formed in the ratio of 1:3. It is predictable that when CBP undergoes a transition from the cation radical state to the excited state, CBP is more likely to- transit to the triplet state where structural change is small. Hence, CBP was expected to be effectively and practically used as a trap site for excitons.

Using the AM1 method, the structures of the lowest excited singlet state and the lowest excited triplet state were optimized and then the energy was determined. The energy gap between the lowest excited singlet and triplet states was 1.59 eV.

In addition, as a compound represented by general formula (2), biphenyl-diphenylamine was investigated. Using, as was the case above, the AM1 method, the structures of the lowest excited singlet state and the lowest excited triplet state were optimized and then the energy was determined. The energy gap between the lowest excited singlet and triplet states was 1.24 eV.

For other compounds represented by general formulae (1) and (2) above, the same results were obtained. The energy gap was also 2 eV or less.

Meanwhile, trans-stilbene, which is generally said to have a high intersystem crossing, was investigated. The energy gap was 2 eV, which was larger than that obtained in the foregoing examples.

### Example 2

In this example, there is described one example of a device having the configuration shown in FIG. 3. On a glass substrate having formed thereon ITO, a hole transporting layer made of N,N′-diphenyl-N,N′-bis(3-methylphenyl)-1,1′-biphenyl-4,4′-diamine, with a thickness of 50 nm was formed. Next, tris(8-qiunolinolato)aluminum and 4,4′-N,N′-dicarbazole-biphenyl were co-deposited at a 10:1 molar ratio to form a luminescent layer with a thickness of 30 nm. Subsequently, an electron transporting layer made of tris(8-quinolinolato)aluminum, with a thickness of 20 nm was formed. On the electron transporting layer, lithium was deposited to 1 nm. Thereafter, a cathode made of aluminum, with a thickness of 100 nm was formed. Thus, a light-emitting device shown in FIG. 3 was fabricated.

A direct current voltage was applied to the light-emitting device of the present example to evaluate the characteristics of the device. With an applied voltage of 4 V, the luminance was about 500 cd/m² and the luminescent efficiency was 5.0 cd/A, and thus stable green luminescence was obtained with a high luminescent efficiency. CIE was (0.35, 0.53). A constant-current luminescence test was performed on the device at an initial luminance of 300 cd/m². The time to half luminance was about 650 hours.

An exciton-forming substance and a luminescent substance were co-deposited such that the number of moles of the exciton-forming substance: the number of moles of the luminescent substance=1 mole: 10 moles to 1 mole: 1 mole, thereby forming a luminescent layer in which the exciton-forming substance was uniformly dispersed in the luminescent substance. A light-emitting device having such a luminescent layer also had an excellent luminescent efficiency and long time to half luminance.

The electron affinity of the above-described tris(8-quinolinolato)aluminum was determined as follows. The ionization potential was measured using an ultraviolet photoelectron spectrometer (AC-1 available from Riken Keiki Co., Ltd.) under an atmosphere, the result of which was 5.7 eV. The energy gap obtained from the absorption edge was 2.7 eV, and therefore the electron, affinity was 3.1 eV. Similarly, the electron affinity of CBP was determined, the result of which was 2.9 eV. This value was relatively small as compared with the electron affinity of aluminumquinohne.

### EXAMPLE 3

In this example, there is described one example of a device having the configuration shown in FIG. 4. On a glass substrate having formed thereon ITO, a hole transporting layer made of N,N′-diphenyl-N,N′-bis(3-methylphenyl)-1,1′-biphenyl-4,4′-diamine, with a thickness of 50 nm was formed. Next, a luminescent layer with a thickness of 30 nm was formed by co-depositing tris(8-quinolinolato)aluminum and 4,4′-N,N′-dicarbazole-biphenyl at a ratio in the range of 20:1 to 1:20 so that the total number of moles in the luminescent layer was 10 moles: 1 mole. Then, an electron transporting layer made of tris(8-quinolinolato)aluminum, with a thickness of 20 nm was formed. On the electron transporting layer, lithium was deposited to 1 nm. Thereafter, a cathode made of aluminum, with a thickness of 100 nm was formed. Thus, a light-emitting device shown in FIG. 4 was fabricated.

A direct current voltage was applied to the light-emitting device of the present example to evaluate the characteristics of the device. With an applied voltage of 4 V, the luminance was about 500 cd/m² and the luminescent efficiency was 5.0 cd/A, and thus stable green luminescence was obtained with a high luminescent efficiency. CIE was (0.35, 0.53). The constant-current luminescence test was performed on the device at an initial luminance of 300 cd/m². The time to half luminance was about 700 hours.

### EXAMPLE 4

In this example, there is described one example of a device having the configuration shown in FIG. 5. In the present example, a luminescent layer 4 was formed in a multilayer structure. Specifically, as is shown in FIG. 5, the luminescent layer 4 had a structure 24 including an exciton-forming layer 21, a luminescent substance layer 22, and an exciton-forming layer 21 stacked on top of each other in sequence. Except for this, the configuration is the same as in Example 2. The exciton-forming layer was made of 4,4′-N,N′-dicarbazole-biphenyl and made to a thickness of 1 nm. The luminescent substance layer was made of tris(4-methyl-8-quinolinolato)aluminum and made to a thickness of 30 nm.

A direct current voltage was applied to the light-emitting device of the present example to evaluate the characteristics of the device. With an applied voltage of 4 V, the luminance was about 650 cd/m² and the luminescent efficiency was 7.6 cd/A, and thus stable blue-green luminescence was obtained with a high luminescent efficiency. The constant-current luminescence test was performed on the device at an initial luminance of 300 cd/m². The time to half luminance was about 800 hours.

### EXAMPLE 5

In this example, there is described one example of a device having the configuration shown in FIG. 6. In the present example, a luminescent layer 4 was formed in a multilayer structure. Specifically, as is shown in FIG. 6, the luminescent layer 4 had a structure 24 including a luminescent substance layer 22, an exciton-forming layer 21, and a luminescent substance layer 22 stacked on top of each other in sequence. Except for this, the configuration is the same as in Example 2. The exciton-forming layer was made of 4,4′-N,N′-dicarbazole-biphenyl and made to a thickness of 1 nm. The luminescent substance layer was made of tris(4-methyl-8-quinolinolato)aluminum and made to a thickness of 30 nm.

A direct current voltage was applied to the light-emitting device of the present example to evaluate the characteristics of the device. With an applied voltage of 4 V, the luminance was about 650 cd/m² and the luminescent efficiency was 7.2 cd/A, and thus stable blue-green luminescence was obtained with a high luminescent efficiency. The constant-current luminescence test was performed on the device at an initial luminance of 300 cd/m². The time to half luminance was about 750 hours.

### EXAMPLE 6

In this example, there is described one example of a device having the configuration shown in FIG. 8. In the present example, the luminescent layer was formed in a multilayer structure. Specifically, as is shown in FIG. 8, the luminescent layer had one multilayer unit 24 including a luminescent substance layer 22 and an exciton-forming layer 21 stacked on top of each other in sequence. This multilayer unit is one form of a light-emitting device shown in FIG. 7. Except for this, the configuration is the same as in Example 2. The exciton-forming layer was made of 4,4-N,N′-dicarbazole-biphenyl and made to a thickness of 1 nm. The luminescent substance layer was made of tris(4-methyl-8-quinolinolato)aluminum and made to a thickness of 10 nm.

A direct current voltage was applied to the light-emitting device of the present example to evaluate the characteristics of the device. With an applied voltage of 4 V, the luminance was about 660 cd/m² and the luminescent efficiency was 5.2 cd/A, and thus stable green luminescence was obtained with a high luminescent efficiency. The constant-current luminescence test was performed on the device at an initial luminance of 300 cd/m². The time to half luminance was about 800 hours.

### EXAMPLE 7

In this example, there is described one example of a device having the configuration shown in FIG. 9. In the present example, the luminescent layer was formed in a multilayer structure. Specifically, as is shown in FIG. 9, the luminescent layer had five multilayer units 23, each having a structure including a luminescent substance layer 22 and an exciton-forming layer 21 stacked on top of each other in sequence. Between a multilayer structure 24 and a hole transporting layer 3, an exciton-forming layer 21 was provided. Except for this, the configuration is the same as in Example 2. The exciton-forming layer was made of 4,4′-N,N′-dicarbazole-biphenyl and made to a thickness of 1 nm. The luminescent substance layer was made of tris(8-quinolinolato)aluminum and made to a thickness of 2 nm.

A direct current voltage was applied to the light-emitting device of the present example to evaluate the characteristics of the device. With an applied voltage of 4 V, the luminance was about 550 cd/m² and the luminescent efficiency was 5.2 cd/A, and thus stable green luminescence was obtained with a high luminescent efficiency. The constant-current luminescence test was performed on the device at an initial luminance of 300 cd/m². The time to half luminance was about 500 hours.

### EXAMPLE 8

In this example, there is described one example of a device having the configuration shown in FIG. 9 In the present example, the luminescent layer was formed in a multilayer structure. Specifically, as is shown in FIG. 9, the luminescent layer had three multilayer units 23, each having a structure including a luminescent substance layer 22 and an exciton-forming layer 21 stacked on top of each other in sequence. Between a multilayer structure 24 and a hole transporting layer 3, an exciton-forming layer 21 was provided. Except for this, the configuration is the same as in Example 2. The exciton-forming layer was made of 4,4′-N,N′-dicarbazole-biphenyl and made to a thickness of 1 nm. The luminescent substance layer was made of tris(8-quinolinolato)aluminum and made to a thickness of 3 nm.

A direct current voltage was applied to the light-emitting device of the present example to evaluate the characteristics of the device. With an applied voltage of 4 V, the luminance was about 600 cd/m² and the luminescent efficiency was 5.0 cd/A, and thus stable green luminescence was obtained with a high luminescent efficiency. The constant-current luminescence test was performed on the device at an initial luminance of 300 cd/m². The time to half luminance was about 500 hours.

### EXAMPLE 9

In this example, there is described one example of a device having the configuration shown in FIG. 10. In the present example, the luminescent layer was formed in a multilayer structure. Specifically, as is shown in FIG. 10, the luminescent layer had ten multilayer units 23, each having a structure including a luminescent substance layer 22 and an exciton-forming layer 21 stacked on top of each other in sequence. Between a multilayer structure 24 and an electron transporting layer 5, a luminescent substance layer 22 with a thickness of 3 nm was provided. Except for this, the configuration is the same as in Example 2. The exciton-forming layer was made of 4,4′-N,N′-dicarbazole-biphenyl and made to a thickness of 1 nm. The luminescent substance layer was made of tris(8-quinolinolato)aluminum and- made to a thickness of 2 nm.

A direct current voltage was applied to the light-emitting device of the present example to evaluate the characteristics of the device. With an applied voltage of 4 V, the luminance was about 500 cd/m² and the luminescent efficiency was 5.2 cd/A, and thus stable green luminescence was obtained with a high luminescent efficiency The constant-current luminescence test was performed on the device at an initial luminance of 300 cd/m². The time to half luminance was about 550 hours.

### EXAMPLE 10

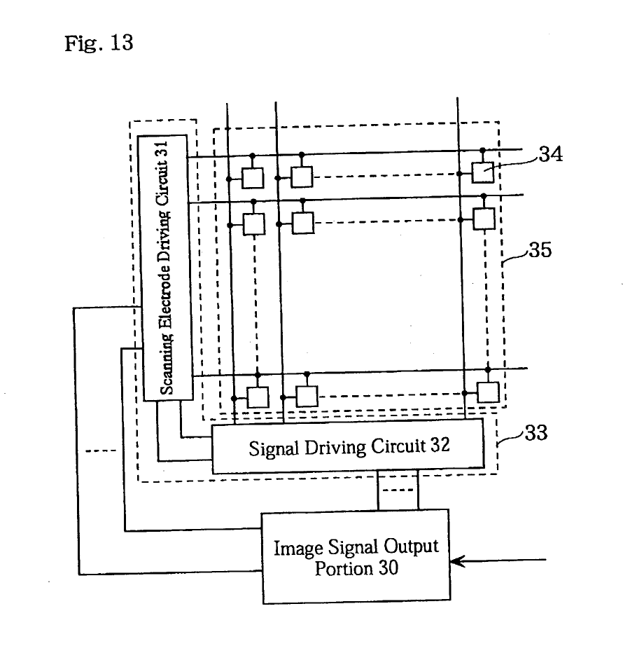

FIG. 13 is a schematic view illustrating one example of a display device using the light-emitting devices of the present invention. In this example, the display device has an image signal output portion 30 for generating image signals, a driving portion 33 including a scanning electrode driving circuit 31 for generating the image signals from the image signal output portion and a signal driving circuit 32, and a luminescence portion 35 including light-emitting devices 34 arranged in a 100×100 matrix. Electroluminescent display devices, such as one shown in FIG. 13, were fabricated in which the light-emitting devices fabricated in Examples 2 to 9 were respectively arranged in a 100×100 matrix. Then, the display devices were allowed to display moving images. All the display devices provided excellent images with high color purity. Many electroluminescent display devices were fabricated, but there were no variations between the display devices, and the display devices had excellent in-plane uniformity.

### EXAMPLE 11

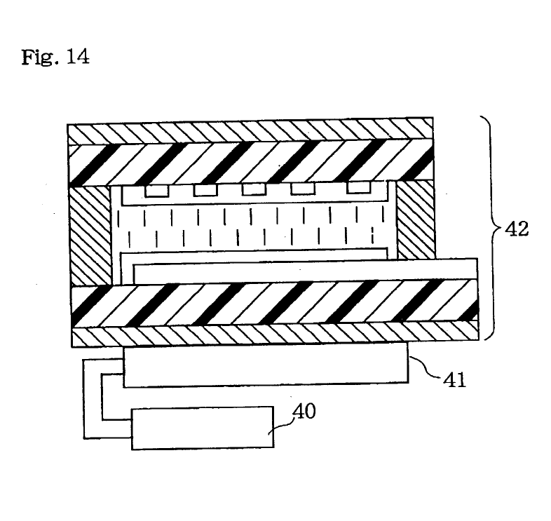

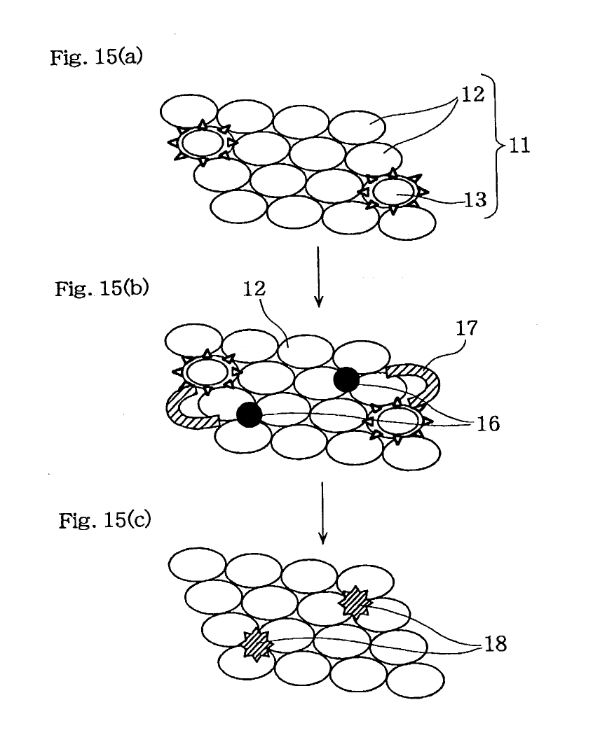

FIG. 14 is a schematic view illustrating one example of a lighting system using the light-emitting device of the present invention. In this example, the lighting system includes a driving portion 40 for generating an electric current and a luminescence portion 41 having a light-emitting device that emits light in accordance with the electric current generated by the driving portion. In this example, the lighting system was used as the backlight for a liquid crystal display panel 42. The light-emitting devices fabricated in Examples 2 to 9 were respectively formed on film substrates, and then a voltage was applied to the devices to produce luminescence. As a result, lighting systems which provided curved, uniform, planar luminescence were obtained without the need to use indirect lighting which leads to the loss of luminance.

Comparative Example 1

A light-emitting device was fabricated in the same manner as described in Example 2, except that the luminescent layer was formed using tris(8-quinolinolato)aluminum and made to a thickness of 30 nm.

A direct current voltage was applied to the light-emitting device of the present example to evaluate the characteristics of the device. With an applied voltage of 4 V, the luminance was about 300 cd/m² and the luminescent efficiency was 2.8 cd/A. Green luminescence with CIE (0.35, 0.53) was obtained. The constant-current luminescence test was performed on the device at an initial luminance of 300 cd/m². The time to half luminance was about 100 hours. The device had a lower luminescent efficiency and lower color stability than the device of Example 2. In addition, the durability of the device was inferior to that of the device of Example 2.

Comparative Example 2

A light-emitting device was fabricated in the same manner as described in Example 3, except that the luminescent layer was formed using tris(4-methyl-8-quinolinolato)aluminum and made to a thickness of 30 nm.

A direct current voltage was applied to the light-emitting device of the present example to evaluate the characteristics of the device. With an applied voltage of 4 V, the luminance was about 410 cd/m² and the luminescent efficiency was 4.5 cd/A. The constant-current luminescence test was performed on the device at an initial luminance of 300 cd/m². The time to half luminance was about 230 hours. The device had a lower luminescent efficiency and lower color stability than the device of Example 2. In addition, the durability of the device was inferior to that of the device of Example 2.

### INDUSTRIAL APPLICABILITY

As has been described above, the exciton-forming substances of the present invention have such properties as to easily form an excited triplet state, and thus can be used as a trap site for excitons.

Furthermore, when such exciton-forming substances are used together with luminescent substances, luminescence of the luminescent substances can be stimulated, and thus the luminescent efficiencies of the luminescent substances can be further enhanced as compared with the case where the luminescent substances are used alone.

VVhen the luminescent materials, which contain the above-described exciton-forming substances and luminescent substances, are used in light-emitting devices, the concentration dependency of the exciton-forming substances is low. Hence, even in mass production processes, the concentration can be easily controlled, and uniformity and reproducibility within the device or between the devices can be easily obtained. In addition, since luminescence occurs only from the luminescent substance but not from the exciton-forming substance, a light-emitting device with good color purity can be obtained. Moreover, the light-emitting devices of the present invention provide mainly fluorescence emission but not phosphorescence emission, and thus fast radiation processes are obtained, and the current efficiency is not reduced even in the high luminance region.

Moreover, energy is transferred by Dexter transfer such that energy is transferred within a short distance, and thus a hole blocking layer is not necessary, facilitating the configuration of the device. In addition, because the hole blocking layer is not required, extended lifetimes are achieved without significantly increasing the operating voltage.

Thus, the value of the present invention to industry is considerable.

What is claimed is:

1. An exciton-forming substance, wherein an energy level difference between an excited singlet state and an excited triplet state is 2 eV or lower.

2. An exciton-forming substance, wherein an energetically stable configuration in a cation radical state and an energetically stable configuration in an excited state resemble each other, and wherein a transition from the cation radical state to the excited state is energetically advantageous.

3. An exciton-forming substance, wherein an energetically stable configuration in a cation radical state and an energetically stable configuration in an excited triplet state resemble each other, and wherein a transition from the cation radical state to the excited triplet state is energetically advantageous.

4. The exciton-forming substance according to any one of claims 1, 2, or 3, wherein the exciton-forming substance is an organic compound represented by the following general formula (1): 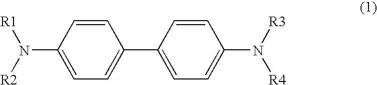
wherein R1 to R4 are each independently selected from the group consisting of an aryl group having 6 to 18 carbon atoms and a heteroaromatic ring having 1 to 3 nitrogen atoms, may be substituted with one or more substituents selected from the group consisting of an alkyl group having 1 to 6 carbon atoms, an aryl group having 6 to 18 carbon atoms, a heteroaromatic ring having 1 to 3 nitrogen atoms, a vinyl group, a styryl group, and a diphenylvinyl group, and may be the same or different; and
R1 and R2 and/or R3 and R4 may be combined together to form a saturated or unsaturated five- or six-membered ring or a fused polycyclic aromatic ring.

5. The exciton-forming substance according to any one of claims 1, 2, or 3, wherein the exciton-forming substance is an organic compound represented by the following general formula (2): 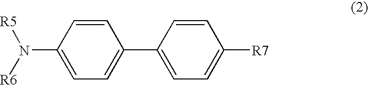
wherein R5 and R6 each independently selected from the group consisting of an aryl group having 6 to 18 carbon atoms and a heteroaromatic ring having 1 to 3 nitrogen atoms, may be substituted with one or more substituents selected from the group consisting of an alkyl group having 1 to 6 carbon atoms, an aryl group having 6 to 18 carbon atoms, and a heteroaromatic ring having 1 to 3 nitrogen atoms, a vinyl group, a styryl group, and a diphenylvinyl group, may be the same or different, and may be combined together to form a saturated or unsaturated five- or six-membered ring or a fused polycyclic aromatic ring; and
R7 is selected from the group consisting of hydrogen, an alkyl group having 1 to 6 carbon atoms, an aryl group having 6 to 18 carbon atoms, a heteroaromatic ring having 1 to 3 nitrogen atoms, a vinyl group, a styryl group, and a diphenylvinyl group.

6. A luminescent material, comprising:
an exciton-forming substance; and
a luminescent substance.

7. A luminescent material, comprising:
an exciton-forming substance wherein an energy level difference between an excited singlet state and an excited triplet state is 2 eV or lower; and
a luminescent substance wherein an energy level of an excited singlet state is equal to or lower than an energy level of the excited triplet state of the exciton-forming substance.

8. A luminescent material, comprising:
an exciton-forming substance wherein an energetically stable configuration in a cation radical state and an energetically stable configuration in an excited triplet state resemble each other, and wherein a transition from the cation radical state to the excited triplet state is energetically advantageous; and
a luminescent substance wherein an energy level of an excited singlet state is equal to or lower than an energy level of the excited triplet state of the exciton-forming substance.

9. The luminescent material according to any one of claims 6, 7, or 8, wherein the exciton-forming substance is an organic compound represented by the following general formula (1): 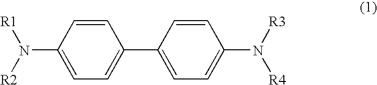
wherein R1 to R4 are each independently selected from the group consisting of an aryl group having 6 to 18 carbon atoms and a heteroaromatic ring having 1 to 3 nitrogen atoms, may be substituted with one or more substituents selected from the group consisting of an alkyl group having 1 to 6 carbon atoms, an aryl group having 6 to 18 carbon atoms, a heteroaromatic ring having 1 to 3 nitrogen atoms, a vinyl group, a styryl group, and a diphenylvinyl group, and may be the same or different; and
R1 and R2 and/or R3 and R4 may be combined together to form a saturated or unsaturated five- or six-membered ring or a fused polycyclic aromatic ring.

10. The luminescent material according to any one of claims 6, 7, or 8, wherein the exciton-forming substance is an organic compound represented by the following general formula (2): 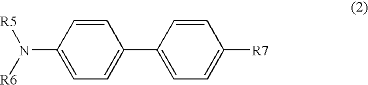
wherein R5 and R6 each independently selected from the group consisting of an aryl group having 6 to 18 carbon atoms and a heteroaromatic ring having 1 to 3 nitrogen atoms, may be substituted with one or more substituents selected from the group consisting of an alkyl group having 1 to 6 carbon atoms, an aryl group having 6 to 18 carbon atoms, and a heteroaromatic ring having 1 to 3 nitrogen atoms, a vinyl group, a styryl group, and a diphenylvinyl group, may be the same or different, and may be combined together to form a saturated or unsaturated five- or six-membered ring or a fused polycyclic aromatic ring; and
R7 is selected from the group consisting of hydrogen, an alkyl group having 1 to 6 carbon atoms, an aryl group having 6 to 18 carbon atoms, a heteroaromatic ring having 1 to 3 nitrogen atoms, a vinyl group, a styryl group, and a diphenylvinyl group.

11. The luminescent material according to any one of claims 6 to 10, wherein a number of moles of the exciton-forming substance contained in the luminescent material is equal to or less than a number of moles of the luminescent substance.

12. A method of producing luminescence in a luminescent substance, comprising:
applying a voltage to a luminescent material, the luminescent material comprising:
an exciton-forming substance wherein an energy level difference between an excited singlet state and an excited triplet state is 2 eV or lower; and
a luminescent substance wherein an energy level of an excited singlet state is equal to or lower than an energy level of the excited triplet state of the exciton-forming substance.

13. A method of producing luminescence in a luminescent substance, comprising:
applying a voltage to a luminescent material, the luminescent material comprising:
an exciton-forming substance wherein an energetically stable configuration in a cation radical state and an energetically stable configuration in an excited triplet state resemble each other, and wherein a transition from the cation radical state to the excited triplet state is allowed; and
a luminescent substance wherein an energy level of an excited singlet state is equal to or lower than an energy level of the excited triplet state of the exciton-forming substance.

14. A light-emitting device comprising an anode, a cathode, and a luminescent layer sandwiched between the anode and the cathode, wherein the luminescent layer contains a luminescent material, the luminescent material comprising:
an exciton-forming substance; and
a luminescent substance.

15. A light-emitting device comprising an anode, a cathode, and a luminescent layer sandwiched between the anode and the cathode, wherein the luminescent layer contains a luminescent material, the luminescent material comprising:
an exciton-forming substance wherein an energy level difference between an excited singlet state and an excited triplet state is 2. eV or lower; and
a luminescent substance wherein an energy level of an excited singlet state is equal to or lower than an energy level of the excited triplet state of the exciton-forming substance.

16. A light-emitting device comprising an anode, a cathode, and a luminescent layer sandwiched between the anode and the cathode, wherein the luminescent layer contains a luminescent material, the luminescent material comprising:
an exciton-forming substance wherein an energetically stable configuration in a cation radical state and an energetically stable configuration in an excited triplet state resemble each other, and wherein a transition from the cation radical state to the excited triplet state is energetically advantageous; and
a luminescent substance wherein an energy level of an excited singlet state is equal to or lower than an energy level of the excited triplet state of the exciton-forming substance.

17. The light-emitting device according to any one of claims 14, 15, or 16, wherein the exciton-forming substance is an organic compound represented by the following general formula (1): 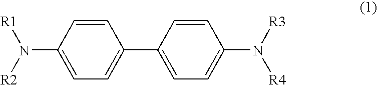
wherein R1 to R4 are each independently selected from the group consisting of an aryl group having 6 to 18 carbon atoms and a heteroaromatic ring having 1 to 3 nitrogen atoms, may be substituted with one or more substituents selected from the group consisting of an alkyl group having 1 to 6 carbon atoms, an aryl group having 6 to 18 carbon atoms, a heteroaromatic ring having 1 to 3 nitrogen atoms, a vinyl group, a styryl group, and a diphenylvinyl group, and may be the same or different; and
R1 and R2 and/or R3 and R4 may be combined together to form a saturated or unsaturated five- or six-membered ring or a fused polycyclic aromatic ring.

18. The light-emitting device according to any one of claims 14, 15, or 16, wherein the exciton-forming substance is an organic compound represented by the following general formula (2): 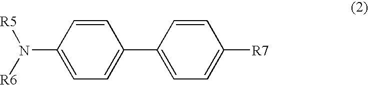
wherein R5 and R6 each independently selected from the group consisting of an aryl group having 6 to 18 carbon atoms and a heteroaromatic ring having 1 to 3 nitrogen atoms, may be substituted with one or more substituents selected from the group consisting of an alkyl group having 1 to 6 carbon atoms, an aryl group having 6 to 18 carbon atoms, and a heteroaromatic ring having 1 to 3 nitrogen atoms, a vinyl group, a styryl group, and a diphenylvinyl group, may be the same or different, and may be combined together to form a saturated or unsaturated five- or six-membered ring or a fused polycyclic aromatic ring; and
R7 is selected from the group consisting of hydrogen, an alkyl group having 1 to 6 carbon atoms, an aryl group having 6 to 18 carbon atoms, a heteroaromatic ring having 1 to 3 nitrogen atoms, a vinyl group, a styryl group, and a diphenylvinyl group.

19. The light-emitting device according to any one of claims 14 to 18, wherein in the luminescent layer the exciton-forming substance is dispersed in the luminescent substance.

20. The light-emitting device according to any one of claims 14 to 18, wherein in the luminescent layer the exciton-forming substance is uniformly dispersed in the luminescent substance.

21. The light-emitting device according to any one of claims 14 to 18, wherein in the luminescent layer the exciton-forming substance is dispersed in the luminescent substance with a concentration gradient.

22. The light-emitting device according to any one of claims 14 to 18, wherein in the luminescent layer the exciton-forming substance is dispersed in the luminescent substance with a concentration gradient in a thickness direction of the luminescent layer, the gradient being such that concentration increases towards the cathode.

23. A light-emitting device comprising an anode, a cathode, and a luminescent layer sandwiched between the anode and the cathode, wherein the luminescent layer is of a multilayer structure, the multilayer structure comprising:
an exciton-forming layer containing an exciton-forming substance; and
a luminescent substance layer containing a luminescent substance.

24. A light-emitting device comprising an anode, a cathode, and a luminescent layer sandwiched between the anode and the cathode, wherein the luminescent layer is of a multilayer structure, the multilayer structure comprising:
an exciton-forming layer containing an exciton-forming substance wherein an energy level difference between an excited singlet state and an excited triplet state is 2 eV or lower; and
a luminescent substance layer containing a luminescent substance wherein an energy level of an excited singlet state is equal to or lower than an energy level of the excited triplet state of the exciton-forming substance.

26. A light-emitting device comprising an anode, a cathode, and a luminescent layer sandwiched between the anode and the cathode, wherein the luminescent layer is of a multilayer structure, the multilayer structure comprising:
an exciton-forming layer containing an exciton-forming substance wherein an energetically stable configuration in a cation radical state and an energetically stable configuration in an excited triplet state resemble each other, and wherein a transition from the cation radical state to the excited triplet state is energetically advantageous; and
a luminescent substance layer containing a luminescent substance wherein an energy level of an excited singlet state is equal to or lower than an energy level of the excited triplet state of the exciton-forming substance.

27. The light-emitting device according to any one of claims 24 to 26, wherein the exciton-forming substance is an organic compound represented by the following general formula (1): 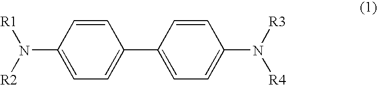
wherein R1 to R4 are each independently selected from the group consisting of an aryl group having 6 to 18 carbon atoms and a heteroaromatic ring having 1 to 3 nitrogen atoms, may be substituted with one or more substituents selected from the group consisting of an alkyl group having 1 to 6 carbon atoms, an aryl group having 6 to 18 carbon atoms, a heteroaromatic ring having 1 to 3 nitrogen atoms, a vinyl group, a styryl group, and a diphenylvinyl group, and may be the same or different; and
R1 and R2 and/or R3 and R4 may be combined together to form a saturated or unsaturated five- or six-membered ring or a fused polycyclic aromatic ring.

28. The light-emitting device according to any one of claims 24 to 26, wherein the exciton-forming substance is an organic compound represented by the following general formula (2): 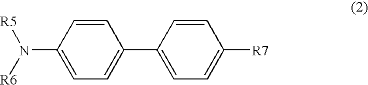
wherein R5 and R6 each independently selected from the group consisting of an aryl group having 6 to 18 carbon atoms and a heteroaromatic ring having 1 to 3 nitrogen atoms, may be substituted with one or more substituents selected from the group consisting of an alkyl group having 1 to 6 carbon atoms, an aryl group having 6 to 18 carbon atoms, and a heteroaromatic ring having 1 to 3 nitrogen atoms, a vinyl group, a styryl group, and a diphenylvinyl group, may be the same or different, and may be combined together to form a saturated or unsaturated five- or six-membered ring or a fused polycyclic aromatic ring; and
R7 is selected from the group consisting of hydrogen, an alkyl group having 1 to 6 carbon atoms, an aryl group having 6 to 18 carbon atoms, a heteroaromatic ring having 1 to 3 nitrogen atoms, a vinyl group, a styryl group, and a diphenylvinyl group.

29. The light-emitting device according to any one of claims 24 to 28, wherein the multilayer structure comprises the exciton-forming layer, the luminescent substance layer, and the exciton-forming layer stacked on top of each other in sequence from the anode side.

30. The light-emitting device according to any one of claims 24 to 28, wherein the multilayer structure comprises the luminescent substance layer, the exciton-forming layer, and the luminescent substance layer stacked on top of each other in sequence from the anode side.

31. The light-emitting device according to any one of claims 24 to 28, wherein the multilayer structure comprises a multilayer unit having a structure including the luminescent substance layer and the exciton-forming layer stacked on top of each other in sequence from the anode side.

32. The light-emitting device according to claim 31, wherein a number of the multilayer unit is in a range of 1 to 250.

33. The light-emitting device according to any one of claims 24 to 32, wherein a total number of moles of the exciton-forming substance contained in the multilayer structure is equal to or less than a total number of moles of the luminescent substance contained in the multilayer structure.

34. The light-emitting device according to any one of claims 24 to 33, wherein a thickness of the multilayer structure is 4 nm to 1000 nm.

35. The light-emitting device according to any one of claims 24 to 34, wherein in the luminescent substance layer and the exciton-forming layer that form the multilayer structure and are stacked on top of each other, a thickness of the exciton-forming layer is equal to or less than that of the luminescent substance layer.

36. A light-emitting device comprising an anode, a cathode, and a luminescent layer sandwiched between the anode and the cathode, the luminescent layer emitting light by electron-hole recombination, wherein:
the luminescent layer containing a luminescent material, the luminescent material comprising an exciton-forming substance and a luminescent substance; and
the electron-hole recombination between luminescent substance molecules is promoted by energy transfer from the exciton-forming substance to the luminescent substance, the energy transfer being accompanied by electron exchange between the luminescent substance and the exciton-forming substance in an excited triplet state.

37. A light-emitting device comprising an anode, a cathode, and a luminescent layer sandwiched between the anode and the cathode, wherein the luminescent layer comprises:
a host material containing a luminescent substance; and
a guest material made of an exciton-forming substance and contained in the host material, wherein
luminescence from the host material is obtained.

38. The light-emitting device according to any one of claims 14 to 37, wherein the exciton-forming substance does not emit light.

39. A light-emitting device comprising an anode, a cathode, and a luminescent layer sandwiched between the anode and the cathode, wherein the luminescent layer comprises:
an exciton-forming substance wherein an energy level difference between an excited singlet state and an excited triplet state is 2 eV or lower; and
a luminescent substance for emitting visible light wherein an energy level of an excited singlet state is equal to or lower than an energy level of the excited triplet state of the exciton-forming substance, and wherein electron affinity is greater than that of the exciton-forming substance.

40. A display device comprising an image signal output portion for generating image signals, a driving portion for generating an electric current in accordance with the image signals generated by the image signal output portion, and a luminescence portion for emitting light in accordance with the electric current generated by the driving portion, wherein:
the luminescence portion includes at least one light-emitting device;
and
the light-emitting device comprises an anode, a cathode, and a luminescent layer sandwiched between the anode and the cathode, the luminescent layer containing a luminescent material, the luminescent material comprising an exciton-forming substance and a luminescent substance.

41. The display device according to claim 40, wherein a plurality of the light-emitting devices are arranged in a matrix on a substrate.

42. The display device according to claim 24, wherein the light-emitting devices are stacked on a substrate having formed thereon thin film transistors for controlling an operation of the light-emitting devices.

43. A lighting system comprising a driving portion for generating an electric current and a luminescence portion for emitting light in accordance with the electric current generated by the driving portion, wherein:
the luminescence portion includes at least one light-emitting device;
and
the light-emitting device comprises an anode, a cathode, and a luminescent layer sandwiched between the anode and the cathode, the luminescent layer containing a luminescent material, the luminescent material comprising an exciton-forming substance and a luminescent substance.

44. (New) The light-emitting device according to any one of claims 11 to 39, wherein the exciton-forming substance is present in an amount of 10 mole % to 50 mole % relative to the luminescent substance.
